(19) United States
(12) Patent Application Publication
(10) Pub. No.: US 2019/0302421 A1
(43) Pub. Date: Oct. 3, 2019

(54) OPTICAL IMAGE CAPTURING SYSTEM

(71) Applicant: ABILITY OPTO-ELECTRONICS TECHNOLOGY CO. LTD., TAICHUNG CITY (TW)

(72) Inventors: Yeong-Ming CHANG, Taichung City (TW); Chien-Hsun LAI, Taichung City (TW); Yao-Wei LIU, Taichung City (TW)

(21) Appl. No.: 16/037,549

(22) Filed: Jul. 17, 2018

(30) Foreign Application Priority Data
Mar. 27, 2018 (TW) 107110556

(51) Int. Cl. G02B 13/00; G02B 9/62

(52) U.S. Cl. CPC G02B 13/0045; G02B 7/04; G02B 13/005; G02B 9/62

(57) ABSTRACT

An optical image capturing system is provided. In order from an object side to an image side, the optical image capturing system includes a first lens, a second lens, a third lens, a fourth lens, a fifth lens and a sixth lens. At least one of lens among the first lens through the fifth lens has positive refractive power. The sixth lens has negative refractive power, and an image side and an object side thereof are aspheric wherein at least one of the image side and the object side thereof has an inflection point. All of the six lenses have refractive power. When meeting some certain conditions, the optical image capturing system may have an outstanding light-gathering ability and adjustment ability about the optical path to elevate the image quality.

### CROSS-REFERENCE TO RELATED APPLICATION

This application claims the benefit of Taiwan Patent Application No. 107110556, filed on Mar. 27, 2018, in the Taiwan Intellectual Property Office, the present invention of which is incorporated herein in its entirety by reference.

### BACKGROUND OF THE INVENTION

### 1. Field of the Invention

The present invention relates to an optical image capturing system, and more particularly to a compact optical image capturing system which can be applied to electronic products.

### 2. Description of the Related Art

In recent years, with the rise of portable electronic devices having camera functionalities, the demand for an optical image capturing system has gradually been raised. The image sensing device of the ordinary photographing camera is commonly selected from a charge coupled device (CCD) or a complementary metal-oxide semiconductor sensor (CMOS Sensor). Also, as advanced semiconductor manufacturing technology enables the minimization of the pixel size of the image sensing device, the development of the optical image capturing system has gravitated towards the field of high pixels. Therefore, the requirement for high imaging quality has been rapidly increasing.

The traditional optical image capturing system of a portable electronic device comes with different designs, including a four-lens or a fifth-lens design. However, the requirement for the higher pixels and the requirement for a large aperture of an end user, like functionalities of micro filming and night view have been raised. The optical image capturing system of prior art cannot meet these high requirements and require a higher order camera lens module.

Therefore, how to effectively increase quantity of incoming light of the optical lenses, and further improve image quality for the image formation, has become an important issue.

### SUMMARY OF THE INVENTION

The aspect of embodiment of the present invention directs to an optical image capturing system and an optical image capturing lens which use combination of refractive power, convex and concave surfaces of six-piece optical lenses (the convex or concave surface in the present invention denotes the change of geometrical shape of an object side or an image side of each lens with different height from an optical axis) to increase the quantity of incoming light of the optical image capturing system, and to improve imaging quality for image formation, so as to be applied to minimized electronic products.

The term and its definition to the lens parameters in the embodiment of the present invention are shown as below for further reference.

The Lens Parameters Related to the Length or the Height

The maximum height for image formation of the optical image capturing system is denoted by HOI. The height of the optical image capturing system is denoted by HOS. The distance from the object side of the first lens to the image side of the sixth lens is denoted by InTL. The distance from an aperture stop (aperture) to an image plane is denoted by InS. The distance from the first lens to the second lens is denoted by In12 (instance). The central thickness of the first lens of the optical image capturing system on the optical axis is denoted by TP1 (instance).

The Lens Parameters Related to the Material

The coefficient of dispersion of the first lens in the optical image capturing system is denoted by NA1 (instance). The refractive index of the first lens is denoted by Nd1 (instance).

The Lens Parameters Related to the Angle of View

The angle of view is denoted by AF. A half angle of view is expressed as HAF. An angle of a chief ray is expressed as MRA.

The Lens Parameters Related to the Exit/Entrance Pupil

The entrance pupil diameter of the optical image capturing system is denoted by HEP. A maximum effective half diameter (EHD) of any surface of the single lens is a perpendicular distance between an optical axis and an intersection point on the surface where the incident light with a maximum angle of view of the system passing the edge of the entrance pupil. For example, the maximum effective half diameter of the object side of the first lens may be expressed as EHD 11. The maximum effective half diameter of the image side of the first lens may be expressed as EHD 12. The maximum effective half diameter of the object side of the second lens may be expressed as EHD 21. The maximum effective half diameter of the image side of the second lens may be expressed as EHD 22. The maximum effective half diameters of any surfaces of other lenses in the optical image capturing system are expressed in a similar way.

The Lens Parameter Related to the Arc Length of the Lens Shape and the Outline of Surface

The length of the outline curve of the maximum effective half diameter position of any surface of a single lens refers to the length of the outline curve from an axial point on the surface of the lens to the maximum effective half diameter position of the surface along an outline of the surface of the lens and is denoted as ARS. For example, the length of the outline curve of the maximum effective half diameter position of the object side of the first lens is denoted as ARS11. The length of the outline curve of the maximum effective half diameter position of the image side of the first lens is denoted as ARS12. The length of the outline curve of the maximum effective half diameter position of the object side of the second lens is denoted as ARS21. The length of the outline curve of the maximum effective half diameter position of the image side of the second lens is denoted as ARS22. The lengths of the outline curves of the maximum effective half diameter positions of any surface of the other lenses in the optical image capturing system are denoted in a similar way as described above.

The length of the outline curve of a half of the entrance pupil diameter (HEP) of any surface of a signal lens refers to the length of the outline curve of the half of the entrance pupil diameter (HEP) from an axial point on the surface of the lens to a coordinate point of vertical height with a distance of the half of the entrance pupil diameter from the optical axis on the surface along the outline of the surface of the lens and is denoted as ARE. For example, the length of the outline curve of the half of the entrance pupil diameter (HEP) of the object side of the first lens is denoted as ARE11. The length of the outline curve of the half of the entrance pupil diameter (HEP) of the image side of the first lens is denoted as ARE12. The length of the outline curve of the half of the entrance pupil diameter (HEP) of the object side of the second lens is denoted as ARE21. The length of the outline curve of the half of the entrance pupil diameter (HEP) of the image side of the second lens is denoted as ARE22. The lengths of outline curves of the half of the entrance pupil diameters (HEP) of any surface of the other lenses in the optical image capturing system are denoted in a similar way as described above.

The Lens Parameter Related to the Surface Depth of the Lens

The horizontal distance parallel to an optical axis from a maximum effective half diameter position to an axial point on the object side of the sixth lens is denoted by InRS61 (a depth of the maximum effective half diameter). The horizontal distance parallel to an optical axis from a maximum effective half diameter position to an axial point on the image side of the sixth lens is denoted by InRS62 (the depth of the maximum effective half diameter). The depths of the maximum effective half diameters (sinkage values) of object sides and image sides of other lenses are denoted in a similar way as described above.

The Lens Parameters Related to the Lens Shape

A critical point is a tangent point on the surface of a specific lens, and the tangent point is tangential to the plane perpendicular to the optical axis and the tangent point cannot be a crossover point on the optical axis. In accordance, the distance perpendicular to the optical axis between a critical point on the object side of the fifth lens and the optical axis is HVT51 (instance). The distance perpendicular to the optical axis between a critical point on the image side of the fifth lens and the optical axis is HVT52 (instance). The distance perpendicular to the optical axis between a critical point on the object side of the sixth lens and the optical axis is HVT61 (instance). The distance perpendicular to the optical axis between a critical point on the image side of the sixth lens and the optical axis is HVT62 (instance). The distances perpendicular to the optical axis between critical points on the object sides or the image sides of other lenses and the optical axis are denoted in a similar way as described above.

The object side of the sixth lens has one inflection point IF611 which is the first nearest to the optical axis, and the sinkage value of the inflection point IF611 is denoted by SGI611. SGI611 is a horizontal distance parallel to the optical axis from an axial point on the object side of the sixth lens to the inflection point which is the first nearest to the optical axis on the object side of the sixth lens. The distance perpendicular to the optical axis between the inflection point IF611 and the optical axis is HIF611 (instance). The image side of the sixth lens has one inflection point IF621 which is the first nearest to the optical axis and the sinkage value of the inflection point IF621 is denoted by SGI621 (instance). SGI621 is a horizontal distance parallel to the optical axis from an axial point on the image side of the sixth lens to the inflection point which is the first nearest to the optical axis on the image side of the sixth lens. The distance perpendicular to the optical axis between the inflection point IF621 and the optical axis is HIF621 (instance).

The object side of the sixth lens has one inflection point IF612 which is the second nearest to the optical axis and the sinkage value of the inflection point IF612 is denoted by SGI612 (instance). SGI612 is a horizontal distance parallel to the optical axis from an axial point on the object side of the sixth lens to the inflection point which is the second nearest to the optical axis on the object side of the sixth lens. The distance perpendicular to the optical axis between the inflection point IF612 and the optical axis is HIF612 (instance). The image side of the sixth lens has one inflection point IF622 which is the second nearest to the optical axis and the sinkage value of the inflection point IF622 is denoted by SGI622 (instance). SGI622 is a horizontal distance parallel to the optical axis from an axial point on the image side of the sixth lens to the inflection point which is the second nearest to the optical axis on the image side of the sixth lens. The distance perpendicular to the optical axis between the inflection point IF622 and the optical axis is HIF622 (instance).

The object side of the sixth lens has one inflection point IF613 which is the third nearest to the optical axis and the sinkage value of the inflection point IF613 is denoted by SGI613 (instance). SGI613 is a horizontal distance parallel to the optical axis from an axial point on the object side of the sixth lens to the inflection point which is the third nearest to the optical axis on the object side of the sixth lens. The distance perpendicular to the optical axis between the inflection point IF613 and the optical axis is HIF613 (instance). The image side of the sixth lens has one inflection point IF623 which is the third nearest to the optical axis and the sinkage value of the inflection point IF623 is denoted by SGI623 (instance). SGI623 is a horizontal distance parallel to the optical axis from an axial point on the image side of the sixth lens to the inflection point which is the third nearest to the optical axis on the image side of the sixth lens. The distance perpendicular to the optical axis between the inflection point IF623 and the optical axis is HIF623 (instance).

The object side of the sixth lens has one inflection point IF614 which is the fourth nearest to the optical axis and the sinkage value of the inflection point IF614 is denoted by SGI614 (instance). SGI614 is a horizontal distance parallel to the optical axis from an axial point on the object side of the sixth lens to the inflection point which is the fourth nearest to the optical axis on the object side of the sixth lens. The distance perpendicular to the optical axis between the inflection point IF614 and the optical axis is HIF614 (instance). The image side of the sixth lens has one inflection point IF624 which is the fourth nearest to the optical axis and the sinkage value of the inflection point IF624 is denoted by SGI624 (instance). SGI624 is a horizontal distance parallel to the optical axis from an axial point on the image side of the sixth lens to the inflection point which is the fourth nearest to the optical axis on the image side of the sixth lens. The distance perpendicular to the optical axis between the inflection point IF624 and the optical axis is HIF624 (instance).

The inflection points on the object sides or the image sides of the other lenses and the distances perpendicular to the optical axis thereof or the sinkage values thereof are denoted in a similar way as described above.

The Lens Parameters Related to the Aberration

Optical distortion for image formation in the optical image capturing system is denoted by ODT. TV distortion for image formation in the optical image capturing system is denoted by TDT. Further, the range of the aberration offset for the view of image formation may be limited to 50%-100%. An offset of the spherical aberration is denoted by DFS. An offset of the coma aberration is denoted by DFC.

The lateral aberration of the edge of the aperture stop is denoted as STA to assess the function of the specific optical image capturing system. The tangential fan or sagittal fan may be applied to calculate the STA of any of light of view fields, and in particular, to calculate the STA of the longest operation wavelength (e.g. 650 nm) and the shortest operation wavelength (e.g. 470 nm) for serve as the standard of the optimal function. The aforementioned direction of the tangential fan can be further defined as the positive (overhead-light) and negative (lower-light) directions. The transverse aberration of the longest operation wavelength passing through the edge of the aperture defines the difference between the image position at the specific field of view where the longest operation wavelength passes through the edge of the aperture and is incident on the image plane and the image position at the specific field of view where the reference primary wavelength (for instance, the wavelength is 555 nm) is incident on the image plane. The transverse aberration of the shortest operation wavelength passing through the edge of the aperture defines the difference between the image position at the specific field of view where the shortest operation wavelength passes through the edge of the aperture and is incident on the image plane and the image position at the specific field of view where the reference primary wavelength (for instance, the wavelength is 555 nm) is incident on the image plane. To evaluate the performance of the specific optical image capturing system, we can utilize that the transverse aberration of the 0.7 field of view (i.e., the 0.7 height of an image HOI) where the longest operation wavelength passes through the edge of the aperture and is incident on the image plane and the transverse aberration of the 0.7 field of view (i.e., the 0.7 height of an image HOI) where the shortest operation wavelength passes through the edge of the aperture and is incident on the image plane (i.e., the 0.7 height of an image HOI) are both less than 100 μm as a way of the examination. Even further, the method of the examination can be that the transverse aberration of the 0.7 field of view where the longest operation wavelength passes through the edge of the aperture and is incident on the image plane and the transverse aberration of the 0.7 field of view where the shortest operation wavelength passes through the edge of the aperture and is incident on the image plane are both less than 80 μm.

The maximum height for image formation on the image plane perpendicular to the optical axis in the optical image capturing system is denoted by HOI. The lateral aberration of the longest operation wavelength of visible light of a positive direction tangential fan of the optical image capturing system passing through an edge of the entrance pupil and incident on the image plane by 0.7 HOI is denoted as PLTA. The lateral aberration of the shortest operation wavelength of visible light of the positive direction tangential fan of the optical image capturing system passing through the edge of the entrance pupil and incident on the image plane by 0.7 HOI is denoted as PSTA. The lateral aberration of the longest operation wavelength of visible light of a negative direction tangential fan of the optical image capturing system passing through the edge of the entrance pupil and incident on the image plane by 0.7 HOI is denoted as NLTA. The lateral aberration of the shortest operation wavelength of visible light of the negative direction tangential fan of the optical image capturing system passing through the edge of the entrance pupil and incident on the image plane by 0.7 HOI is denoted as NSTA. The lateral aberration of the longest operation wavelength of visible light of a sagittal fan of the optical image capturing system passing through the edge of the entrance pupil and incident on the image plane by 0.7 HOI is denoted as SLTA. The lateral aberration of the shortest operation wavelength of visible light of the sagittal fan of the optical image capturing system passing through the edge of the entrance pupil and incident on the image plane by 0.7 HOI is denoted as SSTA.

The present invention provides an optical image capturing system, an object side or an image side of the sixth lens may have inflection points, such that the angle of incidence from each view field to the sixth lens can be adjusted effectively and the optical distortion and the TV distortion can be corrected as well. Further, the surfaces of the sixth lens may have a better optical path adjusting ability to acquire better image quality.

The present invention provides an optical image capturing system, in order from an object side to an image side, including a first lens, a second lens, a third lens, a fourth lens, a fifth lens, a sixth lens and an image plane. The first lens has refractive power. The focal lengths of the first through sixth lenses are respectively f1, f2, f3, f4, f5 and f6. The focal length of the optical image capturing system is f. The entrance pupil diameter of the optical image capturing system is HEP. The distance on an optical axis from an object side of the first lens to the image plane is HOS. The distance on the optical axis from the object side of the first lens to the image side of the sixth lens is InTL. The half maximum angle of view of the optical image capturing system is HAF. The length of the outline curve from an axial point on the any surface of any one of the six lenses to a coordinate point of vertical height with a distance of a half of the entrance pupil diameter from the optical axis on the surface along an outline of the surface is denoted as ARE. The following relationships are satisfied: 1.2≤f/HEP≤10.0, 0<InTL/HOS<0.9 and 0.9≤2(ARE/HEP)≤1.5.

The present invention provides another optical image capturing system, in order from an object side to an image side, including a first lens, a second lens, a third lens, a fourth lens, a fifth lens, a six lens and an image plane. The first lens has negative refractive power. The object side of the first lens close to the optical axis may be convex. The second lens has refractive power. The third lens has refractive power. The fourth lens has refractive power. The fifth lens has refractive power. The sixth lens has refractive power. Both the object side and image side of the sixth lens may be aspheric. The maximum height for image formation on the image plane perpendicular to the optical axis in the optical image capturing system is denoted by HOI. At least one lens of the six lenses is made of glass. At least one lens among the second lens to the sixth lens has positive refractive power. The focal lengths of the first lens through the sixth lens are respectively f1, f2, f3, f4, f5 and f6. The focal length of the optical image capturing system is f. The entrance pupil diameter of the optical image capturing system is HEP. The distance on an optical axis from an object side of the first lens to the image plane is HOS. The distance on the optical axis from the object side of the first lens to the image side of the sixth lens is InTL The length of the outline curve from an axial point on the any surface of any one of the six lenses to a coordinate point of vertical height with a distance of a half of the entrance pupil diameter from the optical axis on the surface along an outline of the surface is denoted as ARE. The following relationships are satisfied: 1.2≤f/HEP≤10.0, 0<InTL/HOS<0.9 and 0.9≤2(ARE/HEP)≤1.5.

The present invention provides another optical image capturing system, in order from an object side to an image side, including a first lens, a second lens, a third lens, a fourth lens, a fifth lens, a sixth lens and an image plane. Wherein, the optical image capturing system comprises the six lenses with refractive power. The maximum height for image formation on the image plane perpendicular to the optical axis in the optical image capturing system is denoted by HOI. At least two lenses among the first lens to the sixth lens are made of glass. Both object side and image side of at least one lens are aspheric. At least one surface of at least one lens among the first lens to the sixth lens has respectively at least one inflection point. The first lens has negative refractive power. The second lens has refractive power. The third lens has refractive power. The fourth lens has refractive power. The fifth lens has positive refractive power. The sixth lens has refractive power. The focal lengths of the first through sixth lenses are respectively f1, f2, f3, f4, f5 and f6. The focal length of the optical image capturing system is f. The entrance pupil diameter of the optical image capturing system is HEP. The distance on an optical axis from an object side of the first lens to the image plane is HOS. The distance on the optical axis from the object side of the first lens to the image side of the sixth lens is InTL. The length of the outline curve from an axial point on any surface of any one of the six lenses to a coordinate point of vertical height with a distance of a half of the entrance pupil diameter from the optical axis on the surface along an outline of the surface is denoted as ARE. The following relationships are satisfied: 1.2≤f/HEP≤3.5, 0<InTL/HOS<0.9 and 0.9≤2(ARE/HEP)≤1.5.

The length of the outline curve of any surface of a signal lens in the maximum effective half diameter position affects the functions of the surface aberration correction and the optical path difference in each view field. The longer outline curve may lead to a better function of aberration correction, but the difficulty in the production may become inevitable. Hence, the length of the outline curve of the maximum effective half diameter position of any surface of a signal lens (ARS) has to be controlled, and especially, the ratio relationship (ARS/TP) between the length of the outline curve of the maximum effective half diameter position of the surface (ARS) and the thickness of the lens to which the surface belongs on the optical axis (TP) has to be controlled. For example, the length of the outline curve of the maximum effective half diameter position of the object side of the first lens is denoted as ARS11, and the thickness of the first lens on the optical axis is TP1, and the ratio between both of them is ARS11/TP1. The length of the outline curve of the maximum effective half diameter position of the image side of the first lens is denoted as ARS12, and the ratio between ARS12 and TP1 is ARS12/TP1. The length of the outline curve of the maximum effective half diameter position of the object side of the second lens is denoted as ARS21. The thickness of the second lens on the optical axis is TP2. The ratio between both of them is ARS21/TP2. The length of the outline curve of the maximum effective half diameter position of the image side of the second lens is denoted as ARS22. The ratio between ARS22 and TP2 is ARS22/TP2. The ratio relationship between the lengths of the outline curve of the maximum effective half diameter position of any surface of the other lenses and the thicknesses of the other lenses to which the surfaces belong on the optical axis (TP) are denoted in a similar way.

The length of the outline curve of any surface of a single lens in the range of the height which is a half entrance pupil diameter (HEP) especially influences the ability of the surface aberration correction in the common area of each field of view of ray and the optical path difference at each field of view. The longer outline curve may lead to a better function of aberration correction, but the difficulty of the production may become inevitable. Therefore, the length of the outline curve from any of the surfaces of a single lens must be controlled in the range of the height which is the half entrance pupil diameter (HEP). Specifically, the ratio (ARE/TP) of the length of the outline curve of the surface (ARE) in the range of the height which is the half entrance pupil diameter (HEP) to the thickness of the lens to which surface belongs on the optical axis (TP) must be controlled. For example, the length of the outline curve of the height which is the half entrance pupil diameter (HEP) of the object side of the first lens is denoted as ARE11. The thickness of the first lens on the optical axis is denoted as TP1. The ratio between ARE11 and TP1 is denoted as ARE11/TP1. The length of the outline curve of the height which is the half entrance pupil diameter (HEP) of the image side of the first lens is denoted as ARE12. The ratio between ARE12 and TP1 is denoted as ARE12/TP1. The length of the outline curve of the height which is the half entrance pupil diameter (HEP) of the object side of the second lens is denoted as ARE21. The thickness of the second lens on the optical axis is denoted as TP2. The ratio between ARE21 and TP2 is denoted as ARE21/TP2. The length of the outline curve of the height which is the half entrance pupil diameter (HEP) of the image side of the second lens is denoted as ARE22. The thickness of the second lens on the optical axis is denoted as TP2. The ratio between ARE22 and TP2 is denoted as ARE22/TP2. The ratio of the length of the outline curve of the height which is the half entrance pupil diameter (HEP) of the surface of the other lens to the thickness of the lens to which surface belongs on the optical axis in the optical image capturing system are expressed in a similar way.

The height of optical image capturing system (HOS) may be reduced to achieve the minimization of the optical image capturing system when the absolute value of f1 is larger than f6 (|f1|>|f6|).

When |f2|+|f3|+|f4|+|f5| and |f1|+|f6| are satisfied with above relationships, at least one of the second through fifth lenses may has weak positive refractive power or weak negative refractive power. The weak refractive power indicates that an absolute value of the focal length of a specific lens is greater than 10. When at least one of the second through fifth lenses has weak positive refractive power, the positive refractive power of the first lens can be shared, such that the unnecessary aberration will not appear too early. On the contrary, when at least one of the second through fifth lenses has weak negative refractive power, the aberration of the optical image capturing system can be corrected and fine tuned.

The sixth lens may have negative refractive power and a concave image side. Hereby, the back focal length is reduced for keeping the miniaturization, to miniaturize the lens effectively. In addition, at least one of the object side and the image side of the sixth lens may has at least one inflection point, such that the angle of incident with incoming light from an off-axis view field can be suppressed effectively and the aberration in the off-axis view field can be corrected further.

### BRIEF DESCRIPTION OF THE DRAWINGS

The detailed structure, operating principles and effects of the present invention will now be described in more details hereinafter with reference to the accompanying drawings that show various embodiments of the present invention as follows.

FIG. 1A is a schematic view of the optical image capturing system according to the first embodiment of the present invention.

FIG. 1B is a curve diagram illustrating the spherical aberration, astigmatism and optical distortion of the optical image capturing system in order from left to right according to the first embodiment of the present invention.

FIG. 1C shows the tangential fan and the sagittal fan of the optical image capturing system and the lateral aberration diagram of the longest operation wavelength and the shortest operation wavelength passing thorough the edge of the aperture at 0.7 field of view according to the first embodiment of the present invention.

FIG. 2A is a schematic view of the optical image capturing system according to the second embodiment of the present invention.

FIG. 2B is a curve diagram illustrating the spherical aberration, astigmatism and optical distortion of the optical image capturing system in order from left to right according to the second embodiment of the present invention.

FIG. 2C shows the tangential fan and the sagittal fan of the optical image capturing system and the lateral aberration diagram of the longest operation wavelength and the shortest operation wavelength passing thorough the edge of the aperture at 0.7 field of view according to the second embodiment of the present invention.

FIG. 3A is a schematic view of the optical image capturing system according to the third embodiment of the present invention.

FIG. 3B a curve diagram illustrating the spherical aberration, astigmatism and optical distortion of the optical image capturing system in order from left to right according to the third embodiment of the present invention.

FIG. 3C shows the tangential fan and the sagittal fan of the optical image capturing system and the lateral aberration diagram of the longest operation wavelength and the shortest operation wavelength passing thorough the edge of the aperture at 0.7 field of view according to the third embodiment of the present invention.

FIG. 4A is a schematic view of the optical image capturing system according to the fourth embodiment of the present invention.

FIG. 4B is a curve diagram illustrating the spherical aberration, astigmatism and optical distortion of the optical image capturing system in order from left to right according to the fourth embodiment of the present invention.

FIG. 4C shows the tangential fan and the sagittal fan of the optical image capturing system and the lateral aberration diagram of the longest operation wavelength and the shortest operation wavelength passing thorough the edge of the aperture at 0.7 field of view according to the fourth embodiment of the present invention.

FIG. 5A is a schematic view of the optical image capturing system according to the fifth embodiment of the present invention.

FIG. 5B is a curve diagram illustrating the spherical aberration, astigmatism and optical distortion of the optical image capturing system in order from left to right according to the fifth embodiment of the present invention.

FIG. 5C shows the tangential fan and the sagittal fan of the optical image capturing system and the lateral aberration diagram of the longest operation wavelength and the shortest operation wavelength passing thorough the edge of the aperture at 0.7 field of view according to the fifth embodiment of the present invention.

FIG. 6A is a schematic view of the optical image capturing system according to the sixth embodiment of the present invention.

FIG. 6B is a curve diagram illustrating the spherical aberration, astigmatism and optical distortion of the optical image capturing system in order from left to right according to the sixth embodiment of the present invention.

FIG. 6C shows the tangential fan and the sagittal fan of the optical image capturing system and the lateral aberration diagram of the longest operation wavelength and the shortest operation wavelength passing thorough the edge of the aperture at 0.7 field of view according to the sixth embodiment of the present invention.

### DETAILED DESCRIPTION OF THE PREFERRED EMBODIMENTS

An optical image capturing system, in order from an object side to an image side, includes a first lens, a second lens, a third lens, a fourth lens, a fifth lens and a sixth lens with refractive power and an image plane. The optical image capturing system may further include an image sensing device which is disposed on an image plane.

The optical image capturing system may use three sets of wavelengths which are respectively 486.1 nm, 587.5 nm and 656.2 nm, wherein 587.5 nm serves as the primary reference wavelength and a reference wavelength for retrieving technical features. The optical image capturing system may also use five sets of wavelengths which are respectively 470 nm, 510 nm, 555 nm, 610 nm and 650 nm, wherein 555 nm serves as the primary reference wavelength and a reference wavelength for retrieving technical features.

The ratio of the focal length f of the optical image capturing system to the focal length fp of each of lenses with positive refractive power is PPR. The ratio of the focal length f of the optical image capturing system to the focal length fn of each of lenses with negative refractive power is NPR. The sum of the PPR of all lenses with positive refractive power is ΣPPR. The sum of the NPR of all lenses with negative refractive power is ΣNPR. It is beneficial to control the total refractive power and the total length of the optical image capturing system when the following condition is satisfied: 0.5≤ΣPPR/|ΣNPR|≤15. Preferably, the following relationship is satisfied: 1≤ΣPPR/|ΣNPR|≤3.0.

The optical image capturing system may further include an image sensing device which is disposed on an image plane. Half of a diagonal of an effective detection field of the image sensing device (imaging height or the maximum image height of the optical image capturing system) is HOI. The distance on the optical axis from the object side of the first lens to the image plane is HOS. The following relationships are satisfied: HOS/HOI≤50 and 0.5≤HOS/f≤150. Preferably, the following relationships are satisfied: 1≤HOS/HOI≤40 and 1≤HOS/f≤140. Hereby, the miniaturization of the optical image capturing system can be maintained effectively, so as to be carried by lightweight portable electronic devices.

In addition, in the optical image capturing system of the present invention, according to different requirements, at least one aperture stop may be arranged for reducing stray light and improving the image quality.

In the optical image capturing system of the present invention, the aperture stop may be a front or middle aperture. The front aperture is the aperture stop between a photographed object and the first lens. The middle aperture is the aperture stop between the first lens and the image plane. If the aperture stop is the front aperture, a longer distance between the exit pupil and the image plane of the optical image capturing system can be formed, such that more optical elements can be disposed in the optical image capturing system and the efficiency of receiving images of the image sensing device can be raised. If the aperture stop is the middle aperture, the angle of view of the optical image capturing system can be expanded, such that the optical image capturing system has the same advantage that is owned by wide angle cameras. A distance from the aperture stop to the image plane is InS. The following relationship is satisfied: 0.1≤InS/HOS≤1.1. Hereby, the miniaturization of the optical image capturing system can be maintained while the feature of the wild-angle lens can be achieved.

In the optical image capturing system of the present invention, the distance from the object side of the first lens to the image side of the sixth lens is InTL. The total central thickness of all lenses with refractive power on the optical axis is ΣTP. The following relationship is satisfied: 0.1≤ΣTP/InTL≤0.9. Hereby, the contrast ratio for the image formation in the optical image capturing system and the yield rate for manufacturing the lens can be given consideration simultaneously, and a proper back focal length is provided to dispose other optical components in the optical image capturing system.

The curvature radius of the object side of the first lens is R1. The curvature radius of the image side of the first lens is R2. The following relationship is satisfied: 0.001≤|R1/R2|≤25. Hereby, the first lens may have proper strength of the positive refractive power, so as to avoid the longitudinal spherical aberration to increase too fast. Preferably, the following relationship is satisfied: 0.01≤|R1/R2|<12.

The curvature radius of the object side of the sixth lens is R11. The curvature radius of the image side of the sixth lens is R12. The following relationship is satisfied: −7<(R11−R12)/(R11+R12)<50. Hereby, the astigmatism generated by the optical image capturing system can be corrected beneficially.

The distance between the first lens and the second lens on the optical axis is IN12. The following relationship is satisfied: IN12/f≤60. Hereby, the chromatic aberration of the lenses can be improved, such that the performance can be increased.

The distance between the fifth lens and the sixth lens on the optical axis is IN56. The following relationship is satisfied: IN56/f≤3.0. Hereby, the chromatic aberration of the lenses can be improved, such that the performance can be increased.

Central thicknesses of the first lens and the second lens on the optical axis are respectively TP1 and TP2. The following relationship is satisfied: 0.1≤(TP1+IN12)/TP2≤10. Hereby, the sensitivity produced by the optical image capturing system can be controlled, and the performance can be increased.

Central thicknesses of the fifth lens and the sixth lens on the optical axis are respectively TP5 and TP6, and a distance between the aforementioned two lenses on the optical axis is IN56. The following relationship is satisfied: 0.1≤(TP6+IN56)/TP5≤15. Hereby, the sensitivity produced by the optical image capturing system can be controlled and the total height of the optical image capturing system can be reduced.

Central thicknesses of the second lens, the third lens and the fourth lens on the optical axis are respectively TP2, TP3 and TP4. The distance between the second and the third lenses on the optical axis is IN23, and the distance between the third and the forth lenses on the optical axis is IN45. The distance between an object side of the first lens and an image side of sixth lens is InTL. The following relationship is satisfied: 0.1≤TP4/(IN34+TP4+IN45)<1. Hereby, the aberration generated by the process of moving the incident light can be adjusted slightly layer upon layer, and the total height of the optical image capturing system can be reduced.

In the optical image capturing system of the first embodiment, the distance perpendicular to the optical axis between a critical point on an object side of the sixth lens and the optical axis is HVT61. The distance perpendicular to the optical axis between a critical point on an image side of the sixth lens and the optical axis is HVT62. The horizontal distance parallel to the optical axis from an axial point on the object side of the sixth lens to the critical point is SGC61. The horizontal distance parallel to the optical axis from an axial point on the image side of the sixth lens to the critical point is SGC62. The following relationship may be satisfied: 0 mm≤HVT61≤3 mm, 0 mm<HVT62≤6 mm, 0≤HVT61/HVT62, 0 mm≤|SGC61|≤0.5 mm; 0 mm<|SGC62|≤2 mm, and 0<|SGC62|/(|SGC62|+TP6)≤0.9. Hereby, the aberration of the off-axis view field can be corrected effectively.

The following relationship is satisfied for the optical image capturing system of the present invention: 0.2≤HVT62/HOI≤0.9. Preferably, the following relationship may be satisfied: 0.3≤HVT62/HOI≤0.8. Hereby, the aberration of surrounding view field for the optical image capturing system can be corrected beneficially.

The following relationship is satisfied for the optical image capturing system of the present invention: 0≤HVT62/HOS≤0.5. Preferably, the following relationship may be satisfied: 0.2≤HVT62/HOS≤0.45. Hereby, the aberration of surrounding view field for the optical image capturing system can be corrected beneficially.

In the optical image capturing system of the present invention, the horizontal distance parallel to an optical axis from an inflection point on the object side of the sixth lens which is the first nearest to the optical axis to an axial point on the object side of the sixth lens is denoted by SGI611. The horizontal distance parallel to an optical axis from an inflection point on the image side of the sixth lens which is the first nearest to the optical axis to an axial point on the image side of the sixth lens is denoted by SGI621. The following relationships are satisfied: 0<SGI611/(SGI611+TP6)≤0.9 and 0<SGI621/(SGI621+TP6)≤0.9. Preferably, the following relationships is satisfied: 0.1≤SGI611/(SGI611+TP6)≤0.6 and 0.1≤SGI621/(SGI621+TP6)≤0.6.

The horizontal distance parallel to the optical axis from the inflection point on the object side of the sixth lens which is the second nearest to the optical axis to an axial point on the object side of the sixth lens is denoted by SGI612. The horizontal distance parallel to an optical axis from an inflection point on the image side of the sixth lens which is the second nearest to the optical axis to an axial point on the image side of the sixth lens is denoted by SGI622. The following relationships are satisfied: 0<SGI612/(SGI612+TP6)≤0.9 and 0<SGI622/(SGI622+TP6)≤0.9. Preferably, the following relationships are satisfied: 0.1≤SGI612/(SGI612+TP6)≤0.6 and 0.1≤SGI622/(SGI622+TP6)≤0.6.

The distance perpendicular to the optical axis between the inflection point on the object side of the sixth lens which is the first nearest to the optical axis and the optical axis is denoted by HIF611. The distance perpendicular to the optical axis between an axial point on the image side of the sixth lens and an inflection point on the image side of the sixth lens which is the first nearest to the optical axis is denoted by HIF621. The following relationships are satisfied: 0.001 mm≤|HIF611|≤5 mm and 0.001 mm≤|HIF621|≤5 mm. Preferably, the following relationships are satisfied: 0.1 mm≤|HIF611|≤3.5 mm and 1.5 mm≤|HIF621|≤3.5 mm.

The distance perpendicular to the optical axis between the inflection point on the object side of the sixth lens which is the second nearest to the optical axis and the optical axis is denoted by HIF612. The distance perpendicular to the optical axis between an axial point on the image side of the sixth lens and an inflection point on the image side of the sixth lens which is the second nearest to the optical axis is denoted by HIF622. The following relationships are satisfied: 0.001 mm≤|HIF612|≤5 mm and 0.001 mm≤|HIF622|≤5 mm Preferably, the following relationships are satisfied: 0.1 mm≤|HIF622|≤3.5 mm and 0.1 mm≤|HIF612|≤3.5 mm.

The distance perpendicular to the optical axis between the inflection point on the object side of the sixth lens which is the third nearest to the optical axis and the optical axis is denoted by HIF613. The distance perpendicular to the optical axis between an axial point on the image side of the sixth lens and an inflection point on the image side of the sixth lens which is the third nearest to the optical axis is denoted by HIF623. The following relationships are satisfied: 0.001 mm≤|HIF613|≤5 mm and 0.001 mm≤|HIF623|≤5 mm. Preferably, the following relationships are satisfied: 0.1 mm≤|HIF623|≤3.5 mm and 0.1 mm≤|HIF613|≤3.5 mm.

The distance perpendicular to the optical axis between the inflection point on the object side of the sixth lens which is the fourth nearest to the optical axis and the optical axis is denoted by HIF614. The distance perpendicular to the optical axis between an axial point on the image side of the sixth lens and an inflection point on the image side of the sixth lens which is the fourth nearest to the optical axis is denoted by HIF624. The following relationships are satisfied: 0.001 mm≤|HIF614|≤5 mm and 0.001 mm≤|HIF624|≤5 mm. Preferably, the following relationships are satisfied: 0.1 mm≤|HIF624|≤3.5 mm and 0.1 mm≤|HIF614|≤3.5 mm.

In one embodiment of the optical image capturing system of the present invention, the chromatic aberration of the optical image capturing system can be corrected by alternatively arranging the lenses with large coefficient of dispersion and small coefficient of dispersion.

The above Aspheric formula is:

z=ch²/[1+[1−(k+1)c²h²]^{0.5}]+A4h⁴+A6h⁶+A8h⁸+A10h¹⁰+A12h¹²+A14h¹⁴+A16h¹⁶+A18h¹⁸+A20h²⁰+ . . . (1),

where z is a position value of the position along the optical axis and at the height h which reference to the surface apex; k is the conic coefficient, c is the reciprocal of curvature radius, and A4, A6, A8, A10, A12, A14, A16, A18, and A20 are high order aspheric coefficients.

In the optical image capturing system provided by the present invention, the lenses may be made of glass or plastic. If plastic material is adopted to produce the lenses, the cost of manufacturing will be lowered effectively. If lenses are made of glass, the heat effect can be controlled and the designed space arranged for the refractive power of the optical image capturing system can be increased. Further, the object side and the image side of the first through sixth lenses may be aspheric, so as to obtain more control variables. Compared with the usage of traditional lens element made of glass, the number of lens elements used can be reduced and the aberration can be eliminated. Thus, the total height of the optical image capturing system can be reduced effectively.

In addition, in the optical image capturing system provided by the present invention, if the lens has a convex surface, the surface of the lens adjacent to the optical axis is convex in principle. If the lens has a concave surface, the surface of the lens adjacent to the optical axis is concave in principle.

The optical image capturing system of the present invention can be adapted to the optical image capturing system with automatic focus if required. With the features of a good aberration correction and a high quality of image formation, the optical image capturing system can be used in various application fields.

The optical image capturing system of the present invention can include a driving module according to the actual requirements. The driving module may be coupled with the lenses to enable the lenses producing displacement. The driving module may be the voice coil motor (VCM) which is applied to move the lens to focus, or may be the optical image stabilization (OIS) which is applied to reduce the distortion frequency owing to the vibration of the lens while shooting.

At least one of the first lens, the second lens, the third lens, the fourth lens, the fifth lens and the sixth lens of the optical image capturing system of the present invention may further be designed as a light filtering element with a wavelength of less than 500 nm according to the actual requirement. The light filter element may be made by coating at least one surface of the specific lens characterized of the filter function, and alternatively, may be made by the lens per se made of the material which is capable of filtering short wavelength.

The image plane of the optical image capturing system of the present invention may be a plane or a curved surface based on the design requirements. When the image plane is a curved surface (e.g. a spherical surface with curvature radius), it is helpful to decrease the required incident angle to focus rays on the image plane. In addition to aiding the miniaturization of the length of the optical image capturing system (TTL), this configuration is helpful to elevate the relative illumination at the same time.

According to the above embodiments, the specific embodiments with figures are presented in detail as below.

### The First Embodiment (Embodiment 1)

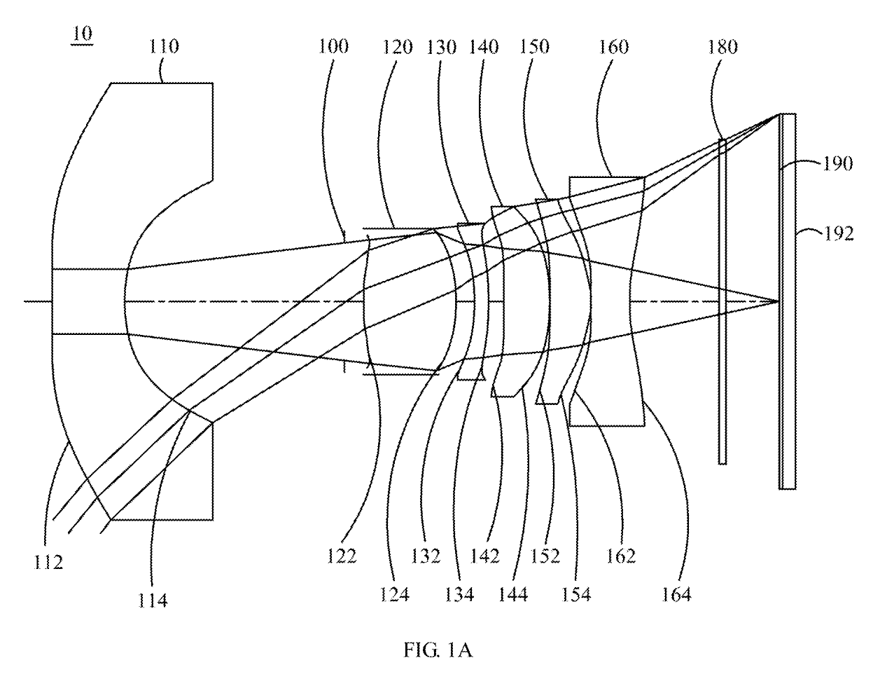

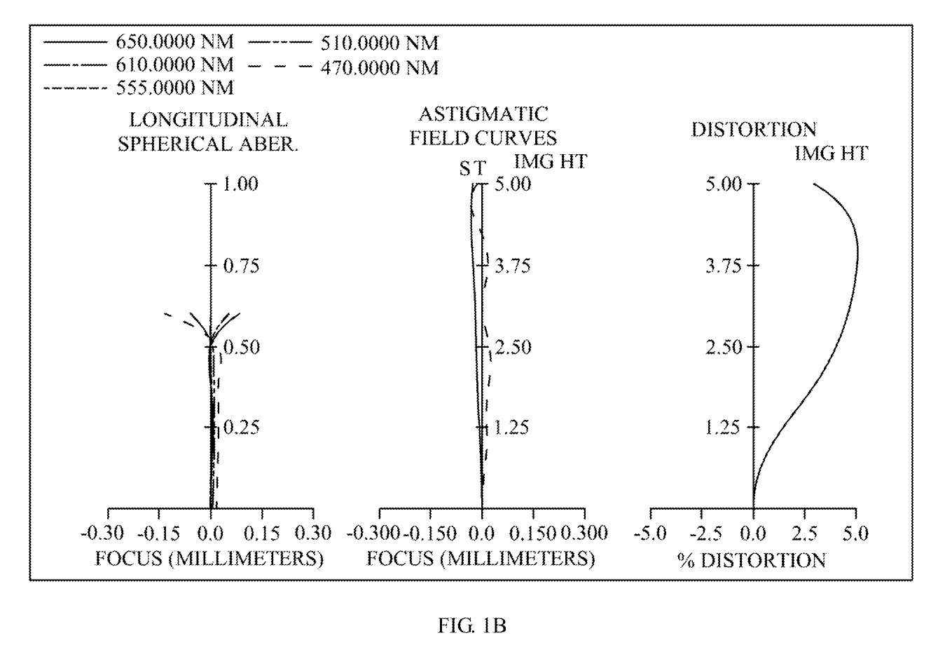

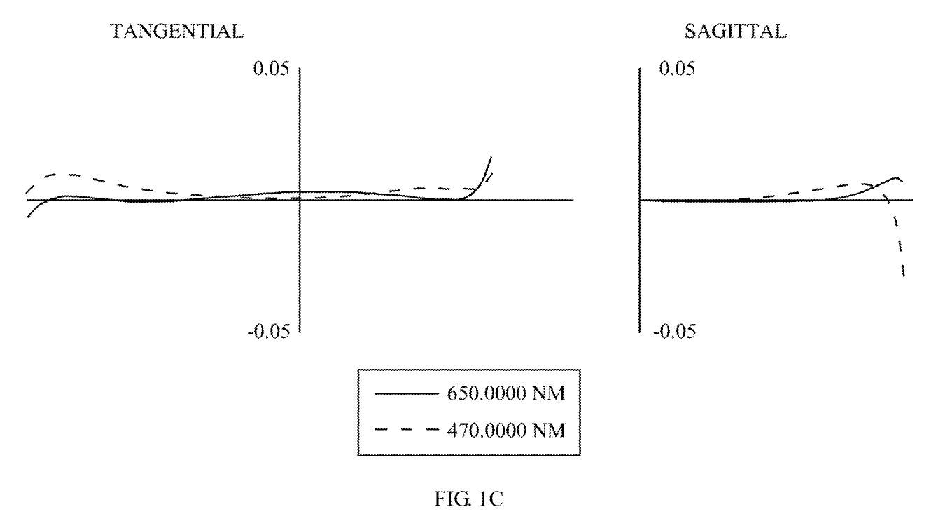

Please refer to FIG. 1A, FIG. 1B and FIG. 1C. FIG. 1A is a schematic view of the optical image capturing system according to the first embodiment of the present invention. FIG. 1B is longitudinal spherical aberration curves, astigmatic field curves, and an optical distortion curve of the optical image capturing system in order from left to right according to the first embodiment of the present invention. FIG. 1C is a lateral aberration diagram of tangential fan, sagittal fan, the longest operation wavelength and the shortest operation wavelength passing through an edge of the entrance pupil and incident on the image plane by 0.7 HOI according to the first embodiment of the present invention. As shown in FIG. 1A, in order from an object side to an image side, the optical image capturing system 10 includes a first lens 110, an aperture stop 100, a second lens 120, a third lens 130, a fourth lens 140, a fifth lens 150, a sixth lens 160, an IR-bandstop filter 180, an image plane 190, and an image sensing device 192.

The first lens 110 has negative refractive power and is made of plastic. The first lens 110 has a concave object side 112 and a concave image side 114. Both of the object side 112 and the image side 114 are aspheric. The object side 112 of the first lens has two inflection points. The length of the outline curve of the maximum effective half diameter position of the object side 112 of the first lens 110 is denoted as ARS11. The length of the outline curve of the maximum effective half diameter position of the image side 114 of the first lens 110 is denoted as ARS12. The length of the outline curve of a half of the entrance pupil diameter (HEP) of the object side 112 of the first lens 110 is denoted as ARE11, and the length of the outline curve of the half of the entrance pupil diameter (HEP) of the image side 114 of the first lens 110 is denoted as ARE12. The thickness of the first lens 110 on the optical axis is TP1.

A horizontal distance parallel to an optical axis from an inflection point on the object side 112 of the first lens 110 which is the first nearest to the optical axis to an axial point on the object side 112 of the first lens 110 is denoted by SGI111. The horizontal distance parallel to an optical axis from an inflection point on the image side 114 of the first lens 110 which is the first nearest to the optical axis to an axial point on the image side 114 of the first lens 110 is denoted by SGI121. The following relationships are satisfied: SGI111=−0.0031 mm and |SGI111|/(|SGI111|+TP1)=0.0016.

The horizontal distance parallel to an optical axis from an inflection point on the object side 112 of the first lens 110 which is the second nearest to the optical axis to an axial point on the object side 112 of the first lens 110 is denoted by SGI112. The horizontal distance parallel to an optical axis from an inflection point on the image side 114 of the first lens 110 which is the second nearest to the optical axis to an axial point on the image side 114 of the first lens 110 is denoted by SGI122. The following relationships are satisfied: SGI112=1.3178 mm and |SGI112|/(|SGI112|+TP1)=0.4052.

The distance perpendicular to the optical axis from the inflection point on the object side 112 of the first lens 110 which is the first nearest to the optical axis to an axial point on the object side 114 of the first lens 110 is denoted by HIF111. The distance perpendicular to the optical axis from the inflection point on the image side 112 of the first lens 110 which is the first nearest to the optical axis to an axial point on the image side 114 of the first lens 110 is denoted by HIF121. The following relationships are satisfied: HIF111=0.5557 mm and HIF111/HOI=0.1111.

The distance perpendicular to the optical axis from the inflection point on the object side 112 of the first lens 110 which is the second nearest to the optical axis to an axial point on the object side 112 of the first lens 110 is denoted by HIF112. A distance perpendicular to the optical axis from the inflection point on the image side 114 of the first lens 110 which is the second nearest to the optical axis to an axial point on the image side 114 of the first lens 110 is denoted by HIF121. The following relationships are satisfied: HIF112=5.3732 mm and HIF112/HOI=1.0746.

The second lens 120 has positive refractive power and is made of plastic. The second lens 120 has a convex object side 122 and a convex image side 124. Both of the object side 122 and the image side 124 are aspheric. The object side 122 has an inflection point. The length of the outline curve of the maximum effective half diameter position of the object side 122 of the second lens 120 is denoted as ARS21, and the length of the outline curve of the maximum effective half diameter position of the image side 124 of the second lens 120 is denoted as ARS22. The length of the outline curve of a half of the entrance pupil diameter (HEP) of the object side 122 of the second lens 120 is denoted as ARE21, and the length of the outline curve of the half of the entrance pupil diameter (HEP) of the image side 124 of the second lens 120 is denoted as ARE22. The thickness of the second lens 120 on the optical axis is TP2.

The horizontal distance parallel to an optical axis from an inflection point on the object side 122 of the second lens 120 which is the first nearest to the optical axis to an axial point on the object side 122 of the second lens 120 is denoted by SGI211. The horizontal distance parallel to an optical axis from an inflection point on the image side 124 of the second lens 120 which is the first nearest to the optical axis to an axial point on the image side 124 of the second lens 120 is denoted by SGI221. The following relationships are satisfied: SGI211=0.1069 mm, |SGI211|/(|SGI211|+TP2)=0.0412, SGI221=0 mm and |SGI221|/(|SGI221|+TP2)=0.

The distance perpendicular to the optical axis from the inflection point on the object side 122 of the second lens 120 which is the first nearest to the optical axis to an axial point on the object side 122 of the second lens 120 is denoted by HIF211. The distance perpendicular to the optical axis from the inflection point on the image side 124 of the second lens 120 which is the first nearest to the optical axis to an axial point on the image side 124 of the second lens 120 is denoted by HIF221. The following relationships are satisfied: HIF211=1.1264 mm, HIF211/HOI=0.2253, HIF221=0 mm and HIF221/HOI=0.

The third lens 130 has negative refractive power and is made of plastic. The third lens 130 has a concave object side 132 and a convex image side 134. Both of the object side 132 and the image side 134 are aspheric. The object side 132 and the image side 134 both have an inflection point. The length of the outline curve of the maximum effective half diameter position of the object side 132 of the third lens 130 is denoted as ARS31, and the length of the outline curve of the maximum effective half diameter position of the image side 134 of the third lens 130 is denoted as ARS32. The length of the outline curve of a half of the entrance pupil diameter (HEP) of the object side 132 of the third lens 130 is denoted as ARE31, and the length of the outline curve of the half of the entrance pupil diameter (HEP) of the image side 134 of the third lens 130 is denoted as ARE32. The thickness of the third lens 130 on the optical axis is TP3.

The horizontal distance parallel to an optical axis from an inflection point on the object side 132 of the third lens 130 which is the first nearest to the optical axis to an axial point on the object side 132 of the third lens 130 is denoted by SGI311. The horizontal distance parallel to an optical axis from an inflection point on the image side 134 of the third lens 130 which is the first nearest to the optical axis to an axial point on the image side 134 of the third lens 130 is denoted by SGI321. The following relationships are satisfied: SGI311=−0.3041 mm, |SGI311|/(|SGI311|+TP3)=0.4445, SGI321=−0.1172 mm and |SGI321|/(|SGI321|+TP3)=0.2357.

The distance perpendicular to the optical axis between the inflection point on the object side 132 of the third lens 130 which is the first nearest to the optical axis and the optical axis is denoted by HIF311. The distance perpendicular to the optical axis from the inflection point on the image side 134 of the third lens 130 which is the first nearest to the optical axis to an axial point on the image side 134 of the third lens 130 is denoted by HIF321. The following relationships are satisfied: HIF311=1.5907 mm, HIF311/HOI=0.3181, HIF321=1.3380 mm and HIF321/HOI=0.2676.

The fourth lens 140 has positive refractive power and is made of plastic. The fourth lens 140 has a convex object side 142 and a concave image side 144. Both of the object side 142 and the image side 144 are aspheric. The object side 142 has two inflection points, and the image side 144 has an inflection point. The length of the outline curve of the maximum effective half diameter position of the object side 142 of the fourth lens 140 is denoted as ARS41. The length of the outline curve of the maximum effective half diameter position of the image side 144 of the fourth lens 140 is denoted as ARS42. The length of the outline curve of a half of the entrance pupil diameter (HEP) of the object side 142 of the fourth lens 140 is denoted as ARE41. The length of the outline curve of the half of the entrance pupil diameter (HEP) of the image side 144 of the fourth lens 140 is denoted as ARE42. The thickness of the fourth lens 140 on the optical axis is TP4.

The horizontal distance parallel to an optical axis from an inflection point on the object side 142 of the fourth lens 140 which is the first nearest to the optical axis to an axial point on the object side 142 of the fourth lens 140 is denoted by SGI411. The horizontal distance parallel to an optical axis from an inflection point on the image side 144 of the fourth lens 140 which is the first nearest to the optical axis to an axial point on the image side 144 of the fourth lens 140 is denoted by SGI421. The following relationships are satisfied: SGI411=0.0070 mm, |SGI411|/(|SGI411|+TP4)=0.0056, SGI421=0.0006 mm and |SGI421|/(|SGI421|+TP4)=0.0005.

The horizontal distance parallel to an optical axis from an inflection point on the object side 142 of the fourth lens 140 which is the second nearest to the optical axis to an axial point on the object side 142 of the fourth lens 140 is denoted by SGI412. The horizontal distance parallel to an optical axis from an inflection point on the image side 144 of the fourth lens 140 which is the second nearest to the optical axis to an axial point on the image side 144 of the fourth lens 140 is denoted by SGI422. The following relationships are satisfied: SGI412=−0.2078 mm and |SGI412|/(|SGI412|+TP4)=0.1439.

The distance perpendicular to the optical axis between the inflection point on the object side 142 of the fourth lens 140 which is the first nearest to the optical axis and the optical axis is denoted by HIF411. The distance perpendicular to the optical axis between the inflection point on the image side 144 of the fourth lens 140 which is the first nearest to the optical axis and the optical axis is denoted by HIF421. The following relationships are satisfied: HIF411=0.4706 mm, HIF411/HOI=0.0941, HIF421=0.1721 mm and HIF421/HOI=0.0344.

The distance perpendicular to the optical axis between the inflection point on the object side 142 of the fourth lens 140 which is the second nearest to the optical axis and the optical axis is denoted by HIF412. The distance perpendicular to the optical axis between the inflection point on the image side 144 of the fourth lens 140 which is the second nearest to the optical axis and the optical axis is denoted by HIF422. The following relationships are satisfied: HIF412=2.0421 mm and HIF412/HOI=0.4084.

The fifth lens 150 has positive refractive power and is made of plastic. The fifth lens 150 has a convex object side 152 and a convex image side 154. Both of the object side 152 and the image side 154 are aspheric. The object side 152 has two inflection points and the image side 154 has an inflection point. The length of the outline curve of the maximum effective half diameter position of the object side 152 of the fifth lens 150 is denoted as ARS51, and the length of the outline curve of the maximum effective half diameter position of the image side 154 of the fifth lens 150 is denoted as ARS52. The length of the outline curve of a half of the entrance pupil diameter (HEP) of the object side 152 of the fifth lens 150 is denoted as ARE51, and the length of the outline curve of the half of the entrance pupil diameter (HEP) of the image side 154 of the fifth lens 150 is denoted as ARE52. The thickness of the fifth lens 150 on the optical axis is TP5.

The horizontal distance parallel to an optical axis from an inflection point on the object side 152 of the fifth lens 150 which is the first nearest to the optical axis to an axial point on the object side 152 of the fifth lens 150 is denoted by SGI511. The horizontal distance parallel to an optical axis from an inflection point on the image side 154 of the fifth lens 150 which is the first nearest to the optical axis to an axial point on the image side 154 of the fifth lens 150 is denoted by SGI521. The following relationships are satisfied: SGI511=0.00364 mm, |SGI511|/(|SGI511|+TP5)=0.00338, SGI521=−0.63365 mm and |SGI521|/(|SGI521|+TP5)=0.37154.

The horizontal distance parallel to an optical axis from an inflection point on the object side 152 of the fifth lens 150 which is the second nearest to the optical axis to an axial point on the object side 152 of the fifth lens 150 is denoted by SGI512. A horizontal distance parallel to an optical axis from an inflection point on the image side 154 of the fifth lens 150 which is the second nearest to the optical axis to an axial point on the image side 154 of the fifth lens 150 is denoted by SGI522. The following relationships are satisfied: SGI512=−0.32032 mm and |SGI512|/(|SGI512 ⊕+TP5)=0.23009.

The horizontal distance parallel to an optical axis from an inflection point on the object side 152 of the fifth lens 150 which is the third nearest to the optical axis to an axial point on the object side 152 of the fifth lens 150 is denoted by SGI513. The horizontal distance parallel to an optical axis from an inflection point on the image side 154 of the fifth lens 150 which is the third nearest to the optical axis to an axial point on the image side 154 of the fifth lens 150 is denoted by SGI523. The following relationships are satisfied: SGI513=0 mm, |SGI513|/(|SGI513|+TP5)=0, SGI523=0 mm and |SGI523|/(|SGI523|+TP5)=0.

The horizontal distance parallel to an optical axis from an inflection point on the object side 152 of the fifth lens 150 which is the fourth nearest to the optical axis to an axial point on the object side 152 of the fifth lens 150 is denoted by SGI514. The horizontal distance parallel to an optical axis from an inflection point on the image side 154 of the fifth lens 150 which is the fourth nearest to the optical axis to an axial point on the image side 154 of the fifth lens 150 is denoted by SGI524. The following relationships are satisfied: SGI514=0 mm, |SGI514|/(|SGI514|+TP5)=0, SGI524=0 mm and |SGI524|/(|SGI524|+TP5)=0.

The distance perpendicular to the optical axis between the inflection point on the object side 152 of the fifth lens 150 which is the first nearest to the optical axis and the optical axis is denoted by HIF511. The distance perpendicular to the optical axis between the inflection point on the image side 154 of the fifth lens 150 which is the first nearest to the optical axis and the optical axis is denoted by HIF521. The following relationships are satisfied: HIF511=0.28212 mm, HIF511/HOI=0.05642, HIF521=2.13850 mm and HIF521/HOI=0.42770.

The distance perpendicular to the optical axis between the inflection point on the object side 152 of the fifth lens 150 which is the second nearest to the optical axis and the optical axis is denoted by HIF512. The distance perpendicular to the optical axis between the inflection point on the image side 154 of the fifth lens 150 which is the second nearest to the optical axis and the optical axis is denoted by HIF522. The following relationships are satisfied: HIF512=2.51384 mm and HIF512/HOI=0.50277.

The distance perpendicular to the optical axis between the inflection point on the object side 152 of the fifth lens 150 which is the third nearest to the optical axis and the optical axis is denoted by HIF513. The distance perpendicular to the optical axis between the inflection point on the image side 154 of the fifth lens 150 which is the third nearest to the optical axis and the optical axis is denoted by HIF523. The following relationships are satisfied: HIF513=0 mm, HIF513/HOI=0, HIF523=0 mm and HIF523/HOI=0.

The distance perpendicular to the optical axis between the inflection point on the object side 152 of the fifth lens 150 which is the fourth nearest to the optical axis and the optical axis is denoted by HIF514. The distance perpendicular to the optical axis between the inflection point on the image side 154 of the fifth lens 150 which is the fourth nearest to the optical axis and the optical axis is denoted by HIF524. The following relationships are satisfied: HIF514=0 mm, HIF514/HOI=0, HIF524=0 mm and HIF524/HOI=0.

The sixth lens 160 has negative refractive power and is made of plastic. The sixth lens 160 has a concave object side 162 and a concave image side 164. The object side 162 has two inflection points and the image side 164 has an inflection point. Hereby, the angle of incident of each view field on the sixth lens 160 can be effectively adjusted and the spherical aberration can thus be improved. The length of the outline curve of the maximum effective half diameter position of the object side 162 of the sixth lens 160 is denoted as ARS61. The length of the outline curve of the maximum effective half diameter position of the image side 164 of the sixth lens 160 is denoted as ARS62. The length of the outline curve of a half of the entrance pupil diameter (HEP) of the object side 162 of the sixth lens 160 is denoted as ARE61. The length of the outline curve of the half of the entrance pupil diameter (HEP) of the image side 164 of the sixth lens 160 is denoted as ARE62. The thickness of the sixth lens 160 on the optical axis is TP6.

The horizontal distance parallel to an optical axis from an inflection point on the object side 162 of the sixth lens 160 which is the first nearest to the optical axis to an axial point on the object side 162 of the sixth lens 160 is denoted by SGI611. The horizontal distance parallel to an optical axis from an inflection point on the image side 164 of the sixth lens 160 which is the first nearest to the optical axis to an axial point on the image side 164 of the sixth lens 160 is denoted by SGI621. The following relationships are satisfied: SGI611=−0.38558 mm, |SGI611|/(|SGI611|+TP6)=0.27212, SGI621=0.12386 mm and |SGI621|/(|SGI621|+TP6)=0.10722.

The horizontal distance parallel to an optical axis from an inflection point on the object side 162 of the sixth lens 160 which is the second nearest to the optical axis to an axial point on the object side 162 of the sixth lens 160 is denoted by SGI612. The horizontal distance parallel to an optical axis from an inflection point on the image side 164 of the sixth lens 160 which is the second nearest to the optical axis to an axial point on the image side 164 of the sixth lens 160 is denoted by SGI622. The following relationships are satisfied: SGI612=−0.47400 mm, |SGI612|/(|SGI612|+TP6)=0.31488, SGI622=0 mm and |SGI622|/(|SGI622|+TP6)=0.

The distance perpendicular to the optical axis between the inflection point on the object side 162 of the sixth lens 160 which is the first nearest to the optical axis and the optical axis is denoted by HIF611. The distance perpendicular to the optical axis between the inflection point on the image side 164 of the sixth lens 160 which is the first nearest to the optical axis and the optical axis is denoted by HIF621. The following relationships are satisfied: HIF611=2.24283 mm, HIF611/HOI=0.44857, HIF621=1.07376 mm and HIF621/HOI=0.21475.

The distance perpendicular to the optical axis between the inflection point on the object side 162 of the sixth lens 160 which is the second nearest to the optical axis and the optical axis is denoted by HIF612. The distance perpendicular to the optical axis between the inflection point on the image side 164 of the sixth lens 160 which is the second nearest to the optical axis and the optical axis is denoted by HIF622. The following relationships are satisfied: HIF612=2.48895 mm and HIF612/HOI=0.49779.

The distance perpendicular to the optical axis between the inflection point on the object side 162 of the sixth lens 160 which is the third nearest to the optical axis and the optical axis is denoted by HIF613. The distance perpendicular to the optical axis between the inflection point on the image side 164 of the sixth lens 160 which is the third nearest to the optical axis and the optical axis is denoted by HIF623. The following relationships are satisfied: HIF613=0 mm, HIF613/HOI=0, HIF623=0 mm and HIF623/HOI=0.

The distance perpendicular to the optical axis between the inflection point on the object side 162 of the sixth lens 160 which is the fourth nearest to the optical axis and the optical axis is denoted by HIF614. The distance perpendicular to the optical axis between the inflection point on the image side 164 of the sixth lens 160 which is the fourth nearest to the optical axis and the optical axis is denoted by HIF624. The following relationships are satisfied: HIF614=0 mm, HIF614/HOI=0, HIF624=0 mm and HIF624/HOI=0.

The IR-bandstop filter 180 is made of glass without affecting the focal length f of the optical image capturing system 10 and is disposed between the sixth lens 160 and the image plane 190.

In the optical image capturing system 10 of the first embodiment, the focal length of the optical image capturing system 10 is f. The entrance pupil diameter of the optical image capturing system 10 is HEP. A half maximum angle of view of the optical image capturing system 10 is HAF. The detailed parameters are shown as below: f=4.075 mm, f/HEP=1.4, HAF=50.001 deg and tan (HAF)=1.1918.

In the optical image capturing system 10 of the first embodiment, the focal length of the first lens 110 is f1 and the focal length of the sixth lens 160 is f6. The following relationships are satisfied: f1=−7.828 mm, |f/f1|=0.52060, f6=−4.886 and |f1|>|f6|.

In the optical image capturing system 10 of the first embodiment, the focal lengths of the second lens 120 to the fifth lens 150 are respectively f2, f3, f4 and f5. The following relationships are satisfied: |f2|+|f3|+|f4|+|f5|=95.50815 mm, |f1|+|f6|=12.71352 mm and |f2|+|f3|+|f4|+|f5|>|f1|+|f6|.

A ratio of the focal length f of the optical image capturing system 10 to the focal length fp of each of lenses with positive refractive power is PPR. A ratio of the focal length f of the optical image capturing system 10 to the focal length fn of each of lenses with negative refractive power is NPR. In the optical image capturing system 10 of the first embodiment, a sum of the PPR of all lenses with positive refractive power is ΣPPR=f/f2+f/f4+f/f5=1.63290. A sum of the NPR of all lenses with negative refractive power is ΣNPR=|f/f1|+|f/f3|+|f/f6|=1.51305, ΣPPR/|ΣNPR|=1.07921. The following relationships are also satisfied: |f/f2|=0.69101, |f/f3|=0.15834, |f/f4|=0.06883, |f/f5|=0.87305 and |f/f6|=0.83412.

In the optical image capturing system 10 of the first embodiment, the distance from the object side 112 of the first lens 110 to the image side 164 of the sixth lens 160 is InTL. The distance from the object side 112 of the first lens to the image plane 190 is HOS. A distance from an aperture 100 to an image plane 190 is InS. Half of a diagonal length of an effective detection field of the image sensing device 192 is HOI. A distance from the image side 164 of the sixth lens 160 to the image plane 190 is BFL. The following relationships are satisfied: InTL+BFL=HOS, HOS=19.54120 mm, HOI=5.0 mm, HOS/HOI=3.90824, HOS/f=4.7952, InS=11.685 mm and InS/HOS=0.59794.

In the optical image capturing system 10 of the first embodiment, a total central thickness of all lenses with refractive power on the optical axis is ΣTP. The following relationships are satisfied: ΣTP=8.13899 mm and ΣTP/InTL=0.52477. Hereby, contrast ratio for the image formation in the optical image capturing system 10 and yield rate for manufacturing the lens can be given consideration simultaneously, and a proper back focal length is provided to dispose other optical components in the optical image capturing system 10.

In the optical image capturing system 10 of the first embodiment, a curvature radius of the object side 112 of the first lens 110 is R1. The curvature radius of the image side 114 of the first lens 110 is R2. The following relationship is satisfied: |R1/R2|=8.99987. Hereby, the first lens 110 may have proper strength of the positive refractive power, so as to avoid the longitudinal spherical aberration to increase too quickly.

In the optical image capturing system 10 of the first embodiment, a curvature radius of the object side 162 of the sixth lens 160 is R11. The curvature radius of the image side 164 of the sixth lens 160 is R12. The following relationship is satisfied: (R11−R12)/(R11+R12)=1.27780. Hereby, the astigmatism generated by the optical image capturing system 10 can be corrected beneficially.

In the optical image capturing system 10 of the first embodiment, a sum of the focal lengths of all lenses with positive refractive power is ΣPP. The following relationships are satisfied: ΣPP=f2+f4+f5=69.770 mm and f5/(f2+f4+f5)=0.067. Hereby, it is favorable for allocating the positive refractive power of the first lens 110 to other positive lenses and the significant aberrations generated in the process of moving the incident light can be suppressed.

In the optical image capturing system 10 of the first embodiment, a sum of the focal lengths of all lenses with negative refractive power is ΣNP. The following relationships are satisfied: ΣNP=f1+f3+f6=−38.451 mm and f6/(f1+f3+f6)=0.127. Hereby, it is favorable for allocating the negative refractive power of the sixth lens 160 to other negative lenses and the significant aberrations generated in the process of moving the incident light can be suppressed.

In the optical image capturing system 10 of the first embodiment, the distance between the first lens 110 and the second lens 120 on the optical axis is IN12. The following relationships are satisfied: IN12=6.418 mm and IN12/f=1.57491. Hereby, the chromatic aberration of the lenses can be improved, such that the performance can be increased.

In the optical image capturing system 10 of the first embodiment, the distance between the fifth lens 150 and the sixth lens 160 on the optical axis is IN56. The following relationships are satisfied: IN56=0.025 mm and IN56/f=0.00613. Hereby, the chromatic aberration of the lenses can be improved, such that the performance can be increased.

In the optical image capturing system 10 of the embodiment, central thicknesses of the first lens 110 and the second lens 120 on the optical axis are respectively TP1 and TP2. The following relationships are satisfied: TP1=1.934 mm, TP2=2.486 mm and (TP1+IN12)/TP2=3.36005. Hereby, the sensitivity produced by the optical image capturing system 10 can be controlled, and the performance can be increased.

In the optical image capturing system 10 of the first embodiment, central thicknesses of the fifth lens 150 and the sixth lens 160 on the optical axis are respectively TP5 and TP6. A distance between the aforementioned two lenses on the optical axis is IN56. The following relationships are satisfied: TP5=1.072 mm, TP6=1.031 mm and (TP6+IN56)/TP5=0.98555. Hereby, the sensitivity produced by the optical image capturing system 10 can be controlled and the total height of the optical image capturing system 10 can be reduced.

In the optical image capturing system 10 of the first embodiment, a distance between the third lens 130 and the fourth lens 140 on the optical axis is IN34. A distance between the fourth lens 140 and the fifth lens 150 on the optical axis is IN45. The following relationships are satisfied: IN34=0.401 mm, IN45=0.025 mm and TP4/(IN34+TP4+IN45)=0.74376. Hereby, the aberration generated by the process of moving the incident light can be adjusted slightly layer upon layer, and the total height of the optical image capturing system 10 can be reduced.

In the optical image capturing system 10 of the first embodiment, the horizontal distance parallel to an optical axis from an axial point to a maximum effective half diameter position on the object side 152 of the fifth lens 150 is InRS51. The horizontal distance parallel to an optical axis from an axial point to a maximum effective half diameter position on the image side 154 of the fifth lens 150 is InRS52. The central thickness of the fifth lens 150 on the optical axis is TP5. The following relationships are satisfied: InRS51=−0.34789 mm, InRS52=−0.88185 mm, |InRS51|/TP5=0.32458 and |InRS52|/TP5=0.82276. Hereby, it is favorable for manufacturing and forming the lens and for maintaining the minimization for the optical image capturing system 10.

In the optical image capturing system 10 of the first embodiment, the distance perpendicular to the optical axis between a critical point on the object side 152 of the fifth lens 150 and the optical axis is HVT51. The distance perpendicular to the optical axis between a critical point on the image side 154 of the fifth lens 150 and the optical axis is HVT52. The following relationships are satisfied: HVT51=0.515349 mm and HVT52=0 mm.

In the optical image capturing system 10 of the first embodiment, the horizontal distance parallel to an optical axis from an axial point to a maximum effective half diameter position on the object side 162 of the sixth lens 160 is InRS61. The horizontal distance parallel to an optical axis from an axial point to a maximum effective half diameter position on the image side 164 of the sixth lens 160 is InRS62. The central thickness of the sixth lens 160 on the optical axis is TP6. The following relationships are satisfied: InRS61=−0.58390 mm, InRS62=0.41976 mm, |InRS61|/TP6=0.56616 and |InRS62|/TP6=0.40700. Hereby, it is favorable for manufacturing and forming the lens and for maintaining the minimization for the optical image capturing system 10.

In the optical image capturing system 10 of the first embodiment, the distance perpendicular to the optical axis between a critical point on the object side 162 of the sixth lens 160 and the optical axis is HVT61. The distance perpendicular to the optical axis between a critical point on the image side 164 of the sixth lens 160 and the optical axis is HVT62. The following relationships are satisfied: HVT61=0 mm and HVT62=0 mm.

In the optical image capturing system 10 of the first embodiment, the following relationship is satisfied: HVT51/HOI=0.1031. Hereby, the aberration of surrounding view field can be corrected.

In the optical image capturing system 10 of the first embodiment, the following relationship is satisfied: HVT51/HOS=0.02634. Hereby, the aberration of surrounding view field can be corrected.

In the optical image capturing system 10 of the first embodiment, the second lens 120, the third lens 130 and the sixth lens 160 have negative refractive power. The coefficient of dispersion of the second lens 120 is NA2. The coefficient of dispersion of the third lens 130 is NA3. An coefficient of dispersion of the sixth lens 160 is NA6. The following relationship is satisfied: NA6/NA2≤1. Hereby, the chromatic aberration of the optical image capturing system 10 can be corrected.

In the optical image capturing system 10 of the first embodiment, TV distortion and optical distortion for image formation in the optical image capturing system 10 are respectively TDT and ODT. The following relationships are satisfied: TDT=2.124% and ODT=5.076%.

In the optical image capturing system 10 of the first embodiment, the lateral aberration of the longest operation wavelength of visible light of a positive direction tangential fan of the optical image capturing system 10 passing through an edge of the aperture 100 and incident on the image plane 190 by 0.7 view field is denoted as PLTA, which is 0.006 mm. The lateral aberration of the shortest operation wavelength of visible light of the positive direction tangential fan of the optical image capturing system 10 passing through the edge of the aperture 100 and incident on the image plane 190 by 0.7 view field is denoted as PSTA, which is 0.005 mm. The lateral aberration of the longest operation wavelength of visible light of a negative direction tangential fan of the optical image capturing system 10 passing through the edge of the aperture 100 and incident on the image plane 190 by 0.7 view field is denoted as NLTA, which is 0.004 mm. The lateral aberration of the shortest operation wavelength of visible light of a negative direction tangential fan of the optical image capturing system 10 passing through the edge of the aperture 100 and incident on the image plane 190 by 0.7 view field is denoted as NSTA, which is −0.007 mm. The lateral aberration of the longest operation wavelength of visible light of a sagittal fan of the optical image capturing system 10 passing through the edge of the aperture 100 and incident on the image plane 190 by 0.7 view field is denoted as SLTA, which is −0.003 mm. The lateral aberration of the shortest operation wavelength of visible light of the sagittal fan of the optical image capturing system 10 passing through the edge of the aperture 100 and incident on the image plane 190 by 0.7 view field is denoted as SSTA, which is 0.008 mm.

Please refer to the following Table 1 and Table 2.

The detailed data of the optical image capturing system 10 of the first embodiment is as shown in Table 1.

TABLE 1
Lens Parameter for the First Embodiment
f (focal length) = 4.075 mm; f/HEP = 1.4;
HAF (half angle of view) = 50.000 deg

| Surface No. | Curvature Radius | | Thickness (mm) | Material |
|---|---|---|---|---|
| 0 | Object | Plane | Plane | |
| 1 | First Lens | −40.99625704 | 1.934 | Plastic |
| 2 | | 4.555209289 | 5.923 | |
| 3 | Aperture | Plane | 0.495 | |
| 4 | Second Lens | 5.333427366 | 2.486 | Plastic |
| 5 | | −6.781659971 | 0.502 | |
| 6 | Third Lens | −5.697794287 | 0.380 | Plastic |
| 7 | | −8.883957518 | 0.401 | |
| 8 | Fourth Lens | 13.19225664 | 1.236 | Plastic |
| 9 | | 21.55681832 | 0.025 | |
| 10 | Fifth Lens | 8.987806345 | 1.072 | Plastic |
| 11 | | −3.158875374 | 0.025 | |
| 12 | Sixth Lens | −29.46491425 | 1.031 | Plastic |
| 13 | | 3.593484273 | 2.412 | |
| 14 | IR-bandstop | Plane | 0.200 | |
| | Filter | | | |
| 15 | | Plane | 1.420 | |
| 16 | Image Plane | Plane | | |

| Surface No. | Refractive Index | Coefficient of Dispersion | Focal Length |
|---|---|---|---|
| 0 | | | |
| 1 | 1.515 | 56.55 | −7.828 |
| 2 | | | |
| 3 | | | |
| 4 | 1.544 | 55.96 | 5.897 |
| 5 | | | |
| 6 | 1.642 | 22.46 | −25.738 |
| 7 | | | |
| 8 | 1.544 | 55.96 | 59.205 |
| 9 | | | |
| 10 | 1.515 | 56.55 | 4.668 |
| 11 | | | |
| 12 | 1.642 | 22.46 | −4.886 |
| 13 | | | |
| 14 | 1.517 | 64.13 | |
| 15 | | | |
| 16 | | | |

Reference Wavelength = 555 nm; Shield Position: the 1st surface with effective aperture radius = 5.800 mm, the 3rd surface with effective aperture radius = 1.570 mm, the 5th surface with effective aperture radius = 1.950 mm

As for the parameters of the aspheric surfaces of the first embodiment, reference is made to Table 2.

TABLE 2
Aspheric Coefficients

| | Surface No. | | | |
|---|---|---|---|---|
| | 1 | 2 | 4 | 5 |
| k | 4.310876E+01 | −4.707622E+00 | 2.616025E+00 | 2.445397E+00 |
| A4 | 7.054243E−03 | 1.714312E−02 | −8.377541E−03 | −1.789549E−02 |
| A6 | −5.233264E−04 | −1.502232E−04 | −1.838068E−03 | −3.657520E−03 |
| A8 | 3.077890E−05 | −1.359611E−04 | 1.233332E−03 | −1.131622E−03 |
| A10 | −1.260650E−06 | 2.680747E−05 | −2.390895E−03 | 1.390351E−03 |
| A12 | 3.319093E−08 | −2.017491E−06 | 1.998555E−03 | −4.152857E−04 |
| A14 | −5.051600E−10 | 6.604615E−08 | −9.734019E−04 | 5.487286E−05 |
| A16 | 3.380000E−12 | −1.301630E−09 | 2.478373E−04 | −2.919339E−06 |
| | Surface No. | | | |
| | 6 | 7 | 8 | 9 |
| k | 5.645686E+00 | −2.117147E+01 | −5.287220E+00 | 6.200000E+01 |
| A4 | −3.379055E−03 | −1.370959E−02 | −2.937377E−02 | −1.359965E−01 |
| A6 | −1.225453E−03 | 6.250200E−03 | 2.743532E−03 | 6.628518E−02 |
| A8 | −5.979572E−03 | −5.854426E−03 | −2.457574E−03 | −2.129167E−02 |
| A10 | 4.556449E−03 | 4.049451E−03 | 1.874319E−03 | 4.396344E−03 |
| A12 | −1.177175E−03 | −1.314592E−03 | −6.013661E−04 | −5.542899E−04 |
| A14 | 1.370522E−04 | 2.143097E−04 | 8.792480E−05 | 3.768879E−05 |
| A16 | −5.974015E−06 | −1.399894E−05 | −4.770527E−06 | −1.052467E−06 |
| | Surface No. | | | |
| | 10 | 11 | 12 | 13 |
| k | −2.114008E+01 | −7.699904E+00 | −6.155476E+01 | −3.120467E−01 |
| A4 | −1.263831E−01 | −1.927804E−02 | −2.492467E−02 | −3.521844E−02 |
| A6 | 6.965399E−02 | 2.478376E−03 | −1.835360E−03 | 5.629654E−03 |
| A8 | −2.116027E−02 | 1.438785E−03 | 3.201343E−03 | −5.466925E−04 |
| A10 | 3.819371E−03 | −7.013749E−04 | −8.990757E−04 | 2.231154E−05 |
| A12 | −4.040283E−04 | 1.253214E−04 | 1.245343E−04 | 5.548990E−07 |
| A14 | 2.280473E−05 | −9.943196E−06 | −8.788363E−06 | −9.396920E−08 |
| A16 | −5.165452E−07 | 2.898397E−07 | 2.494302E−07 | 2.728360E−09 |

The numerical data related to the length of the outline curve is shown according to table 1 and table 2.

First Embodiment (Primary Reference Wavelength = 555 nm)

| ARE | ½(HEP) | ARE value | ARE − ½(HEP) | 2(ARE/HEP) % | TP | ARE/TP (%) |
|---|---|---|---|---|---|---|
| 11 | 1.455 | 1.455 | −0.00033 | 99.98% | 1.934 | 75.23% |
| 12 | 1.455 | 1.495 | 0.03957 | 102.72% | 1.934 | 77.29% |
| 21 | 1.455 | 1.465 | 0.00940 | 100.65% | 2.486 | 58.93% |
| 22 | 1.455 | 1.495 | 0.03950 | 102.71% | 2.486 | 60.14% |
| 31 | 1.455 | 1.486 | 0.03045 | 102.09% | 0.380 | 391.02% |
| 32 | 1.455 | 1.464 | 0.00830 | 100.57% | 0.380 | 385.19% |
| 41 | 1.455 | 1.458 | 0.00237 | 100.16% | 1.236 | 117.95% |
| 42 | 1.455 | 1.484 | 0.02825 | 101.94% | 1.236 | 120.04% |
| 51 | 1.455 | 1.462 | 0.00672 | 100.46% | 1.072 | 136.42% |
| 52 | 1.455 | 1.499 | 0.04335 | 102.98% | 1.072 | 139.83% |
| 61 | 1.455 | 1.465 | 0.00964 | 100.66% | 1.031 | 142.06% |
| 62 | 1.455 | 1.469 | 0.01374 | 100.94% | 1.031 | 142.45% |

| ARS | EHD | ARS value | ARS − EHD | (ARS/EHD) % | TP | ARS/TP (%) |
|---|---|---|---|---|---|---|
| 11 | 5.800 | 6.141 | 0.341 | 105.88% | 1.934 | 317.51% |
| 12 | 3.299 | 4.423 | 1.125 | 134.10% | 1.934 | 228.70% |
| 21 | 1.664 | 1.674 | 0.010 | 100.61% | 2.486 | 67.35% |
| 22 | 1.950 | 2.119 | 0.169 | 108.65% | 2.486 | 85.23% |
| 31 | 1.980 | 2.048 | 0.069 | 103.47% | 0.380 | 539.05% |
| 32 | 2.084 | 2.101 | 0.017 | 100.83% | 0.380 | 552.87% |
| 41 | 2.247 | 2.287 | 0.040 | 101.80% | 1.236 | 185.05% |
| 42 | 2.530 | 2.813 | 0.284 | 111.22% | 1.236 | 227.63% |
| 51 | 2.655 | 2.690 | 0.035 | 101.32% | 1.072 | 250.99% |
| 52 | 2.764 | 2.930 | 0.166 | 106.00% | 1.072 | 273.40% |
| 61 | 2.816 | 2.905 | 0.089 | 103.16% | 1.031 | 281.64% |
| 62 | 3.363 | 3.391 | 0.029 | 100.86% | 1.031 | 328.83% |

Table 1 is the detailed structure data to the first embodiment in FIG. 1A, wherein the unit of the curvature radius, the thickness, the distance, and the focal length is millimeters (mm). Surfaces 0-16 illustrate the surfaces from the object side to the image plane in the optical image capturing system. Table 2 is the aspheric coefficients of the first embodiment, wherein k is the conic coefficient in the aspheric surface formula, and A1-A20 are the first to the twentieth order aspheric surface coefficient. Furthermore, the tables in the following embodiments are respectively in reference to the schematic view and the aberration graphs, and definitions of parameters in the tables are equal to those in the Table 1 and the Table 2, so the repetitious details will not be given here.

### The Second Embodiment (Embodiment 2)

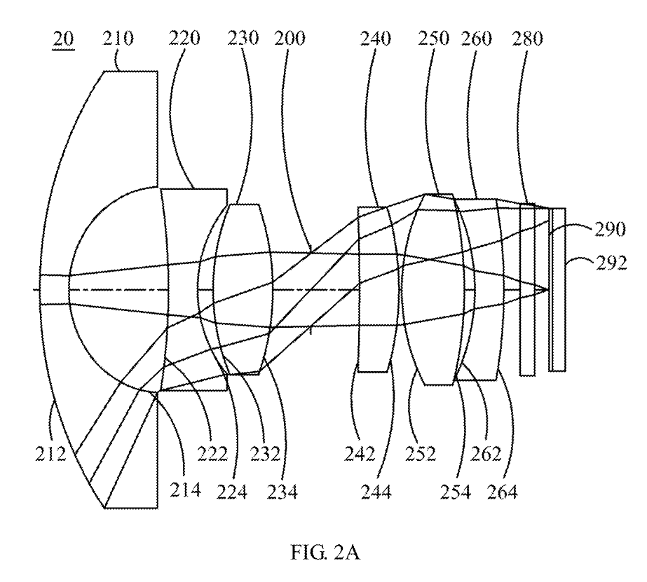

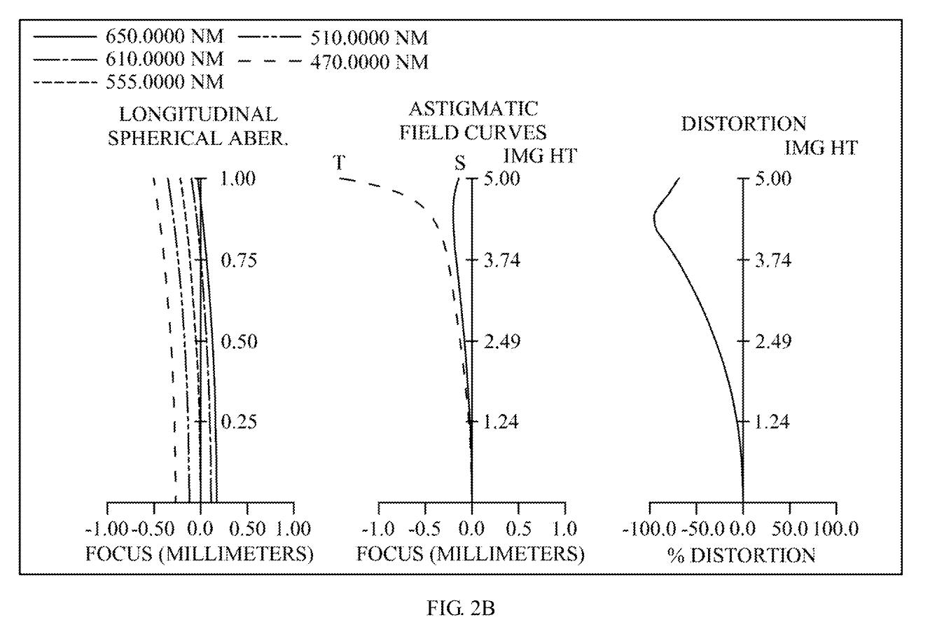

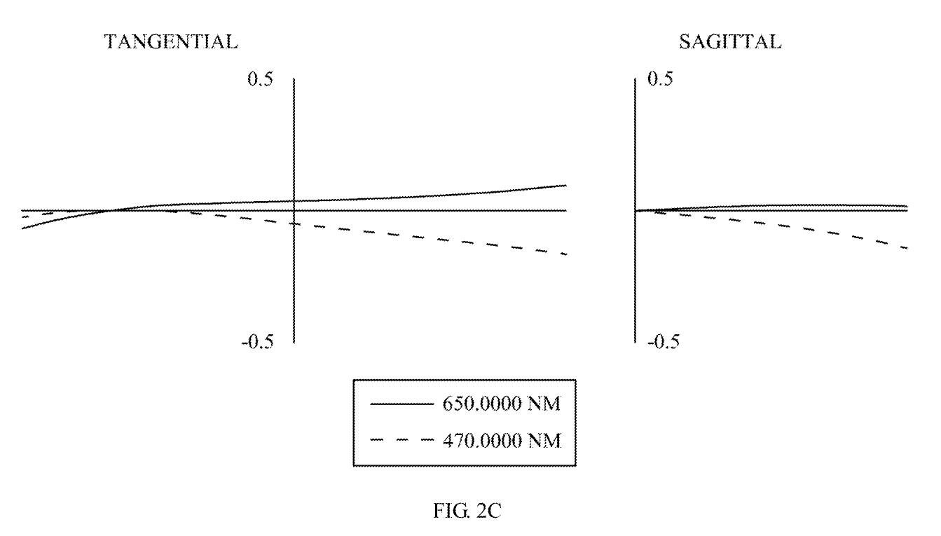

Please refer to FIG. 2A, FIG. 2B and FIG. 2C. FIG. 2A is a schematic view of the optical image capturing system according to the second embodiment of the present invention. FIG. 2B is longitudinal spherical aberration curves, astigmatic field curves, and an optical distortion curve of the optical image capturing system in the order from left to right according to the second embodiment of the present invention. FIG. 2C is a lateral aberration diagram of tangential fan, sagittal fan, the longest operation wavelength and the shortest operation wavelength passing through an edge of the entrance pupil and incident on the image plane by 0.7 HOI according to the second embodiment of the present invention. As shown in FIG. 2A, in order from an object side to an image side, the optical image capturing system 20 includes a first lens 210, a second lens 220, a third lens 230, an aperture stop 200, a fourth lens 240, a fifth lens 250, a sixth lens 260, an IR-bandstop filter 280, an image plane 290, and an image sensing device 292.

The first lens 210 has negative refractive power and is made of glass. The first lens 210 has a convex object side 212 and a concave image side 214. Both of the object side 212 and the image side 214 of the first lens 210 are spherical.

The second lens 220 has negative refractive power and is made of glass. The second lens 220 has a concave object side 222 and a concave image side 224. Both of the object side 222 and the image side 224 of the second lens 220 are spherical.

The third lens 230 has positive refractive power and is made of glass. The third lens 230 has a convex object side 232 and a convex image side 234. Both of the object side 232 and the image side 234 of the third lens 230 are spherical.

The fourth lens 240 has positive refractive power and is made of glass. The fourth lens 240 has a concave object side 242 and a convex image side 244. Both of the object side 242 and the image side 244 of the fourth lens 240 are spherical.

The fifth lens 250 has positive refractive power and is made of glass. The fifth lens 250 has a convex object side 252 and a convex image side 254. Both of the object side 252 and the image side 254 of the fifth lens 250 are spherical.

The sixth lens 260 has negative refractive power and is made of glass. The sixth lens 260 has a concave object side 262 and a convex image side 264. Both of the object side 262 and the image side 264 of the sixth lens 260 are spherical. Hereby, the back focal length is reduced to miniaturize the lens effectively. In addition, the angle of incident with incoming light from an off-axis view field can be suppressed effectively and the aberration in the off-axis view field can be corrected further.

The IR-bandstop filter 280 is made of glass without affecting the focal length f of the optical image capturing system 20 and is disposed between the sixth lens 260 and the image plane 290.

Please refer to the following Table 3 and Table 4.

The detailed data of the optical image capturing system 20 of the second embodiment is as shown in Table 3.

TABLE 3
Lens Parameter for the Second Embodiment
f (focal length) = 2.944 mm; f/HEP = 1.6;
HAF (half angle of view) = 100 deg

| Surface No. | Curvature Radius | | Thickness (mm) | Material |
|---|---|---|---|---|
| 0 | Object | 1E+18 | 1E+18 | |
| 1 | First Lens | 22.93525274 | 2.000 | Glass |
| 2 | | 6.385577732 | 6.842 | |
| 3 | Second Lens | −37.66765484 | 2.000 | Glass |
| 4 | | 7.769637136 | 1.076 | |
| 5 | Third Lens | 12.60854892 | 4.100 | Glass |
| 6 | | −14.64734886 | 2.615 | |
| 7 | Aperture | 1E+18 | 3.334 | |
| 8 | Fourth Lens | −116.9176455 | 2.713 | Glass |
| 9 | | −16.59684295 | 0.200 | |
| 10 | fifth Lens | 11.8226766 | 4.300 | Glass |
| 11 | | −22.2558827 | 0.721 | |
| 12 | Sixth Lens | −11.76450909 | 2.000 | Glass |
| 13 | | −29.62702073 | 1.100 | |
| 14 | IR-bandstop | 1E+18 | 1.000 | BK_7 |
| | Filter | | | |
| 15 | | 1E+18 | 1.000 | |
| 16 | Image Plane | 1E+18 | 0.000 | |

| Surface No. | Refractive Index | Coefficient of Dispersion | Focal Length |
|---|---|---|---|
| 0 | | | |
| 1 | 2.001 | 29.13 | −9.35336 |
| 2 | | | |
| 3 | 1.702 | 41.15 | −8.9776 |
| 4 | | | |
| 5 | 1.946 | 17.98 | 7.65529 |
| 6 | | | |
| 7 | | | |
| 8 | 2.001 | 29.13 | 18.9472 |
| 9 | | | |
| 10 | 2.001 | 29.13 | 8.1841 |
| 11 | | | |
| 12 | 1.946 | 17.98 | −21.6072 |
| 13 | | | |
| 14 | 1.517 | 64.13 | |
| 15 | | | |
| 16 | | | |

Reference Wavelength = 555 nm

As for the parameters of the aspheric surfaces of the second embodiment, reference is made to Table 4.

TABLE 4
Aspheric Coefficients

| | Surface No. | | | |
|---|---|---|---|---|
| | 1 | 2 | 3 | 4 |
| k | 0.000000E+00 | 0.000000E+00 | 0.000000E+00 | 0.000000E+00 |
| A4 | 0.000000E+00 | 0.000000E+00 | 0.000000E+00 | 0.000000E+00 |
| A6 | 0.000000E+00 | 0.000000E+00 | 0.000000E+00 | 0.000000E+00 |
| A8 | 0.000000E+00 | 0.000000E+00 | 0.000000E+00 | 0.000000E+00 |
| A10 | 0.000000E+00 | 0.000000E+00 | 0.000000E+00 | 0.000000E+00 |
| | Surface No. | | | |
| | 5 | 6 | 8 | 9 |
| k | 0.000000E+00 | 0.000000E+00 | 0.000000E+00 | 0.000000E+00 |
| A4 | 0.000000E+00 | 0.000000E+00 | 0.000000E+00 | 0.000000E+00 |
| A6 | 0.000000E+00 | 0.000000E+00 | 0.000000E+00 | 0.000000E+00 |
| A8 | 0.000000E+00 | 0.000000E+00 | 0.000000E+00 | 0.000000E+00 |
| A10 | 0.000000E+00 | 0.000000E+00 | 0.000000E+00 | 0.000000E+00 |
| | Surface No. | | | |
| | 10 | 11 | 12 | 13 |
| k | 0.000000E+00 | 0.000000E+00 | 0.000000E+00 | 0.000000E+00 |
| A4 | 0.000000E+00 | 0.000000E+00 | 0.000000E+00 | 0.000000E+00 |
| A6 | 0.000000E+00 | 0.000000E+00 | 0.000000E+00 | 0.000000E+00 |
| A8 | 0.000000E+00 | 0.000000E+00 | 0.000000E+00 | 0.000000E+00 |
| A10 | 0.000000E+00 | 0.000000E+00 | 0.000000E+00 | 0.000000E+00 |

In the second embodiment, the presentation of the aspheric surface formula is similar to that in the first embodiment. Furthermore, the definitions of the parameters in following tables are equal to those in the first embodiment, so the repetitious details will not be given here.

The following contents may be deduced from Table 3 and Table 4.

Second Embodiment (Primary reference wavelength = 555 nm)

| \|f/f1\| | \|f/f2\| | \|f/f3\| | \|f/f4\| | \|f/f5\| | \|f/f6\| |
|---|---|---|---|---|---|
| 0.31481 | 0.32798 | 0.38463 | 0.15541 | 0.35978 | 0.13627 |
| | | | | | TP4/ |
| ΣPPR | ΣNPR | ΣPPR/\|ΣNPR\| | IN12/f | IN56/f | (IN34 + TP4 + IN45) |
| 0.67631 | 1.00257 | 0.67458 | 2.32368 | 0.24471 | 0.30614 |
| \|f1/f2\| | \|f2/f3\| | (TP1 + IN12)/TP2 | | (TP6 + IN56)/TP5 | |
| 1.04186 | 1.17273 | 4.42102 | | 0.63269 | |
| HOS | InTL | HOS/HOI | InS/HOS | ODT % | TDT % |
| 35.00030 | 31.90040 | 7.00006 | 0.46762 | −128.98900 | 86.54440 |
| HVT51 | HVT52 | HVT61 | HVT62 | HVT62/HOI | HVT62/HOS |
| 0 | 0 | 0 | 0 | 0 | 0 |
| TP2/TP3 | TP3/TP4 | InRS61 | InRS62 | \|InRS61\|/TP6 | \|InRS62\|/TP6 |
| 0.48781 | 1.51118 | −1.39856 | −0.53153 | 0.69928 | 0.26576 |
| PSTA | PLTA | NSTA | NLTA | SSTA | SLTA |
| −0.166 mm | 0.096 mm | −0.025 mm | −0.067 mm | −0.142 mm | 0.016 mm |

The numerical data related to the length of the outline curve is shown according to table 3 and table 4.

Second Embodiment (Primary Reference Wavelength = 555 nm)

| ARE | ½(HEP) | ARE value | ARE − ½(HEP) | 2 (ARE/HEP) % | TP | ARE/TP (%) |
|---|---|---|---|---|---|---|
| 11 | 0.920 | 0.920 | 0.00011 | 100.01% | 2.000 | 46.01% |
| 12 | 0.920 | 0.923 | 0.00307 | 100.33% | 2.000 | 46.16% |
| 21 | 0.920 | 0.920 | −0.00005 | 99.99% | 2.000 | 46.00% |
| 22 | 0.920 | 0.922 | 0.00202 | 100.22% | 2.000 | 46.11% |
| 31 | 0.920 | 0.921 | 0.00068 | 100.07% | 4.100 | 22.46% |
| 32 | 0.920 | 0.921 | 0.00046 | 100.05% | 4.100 | 22.45% |
| 41 | 0.920 | 0.920 | −0.00013 | 99.99% | 2.713 | 33.91% |
| 42 | 0.920 | 0.920 | 0.00033 | 100.04% | 2.713 | 33.93% |
| 51 | 0.920 | 0.921 | 0.00079 | 100.09% | 4.300 | 21.42% |
| 52 | 0.920 | 0.920 | 0.00012 | 100.01% | 4.300 | 21.40% |
| 61 | 0.920 | 0.921 | 0.00080 | 100.09% | 2.000 | 46.05% |
| 62 | 0.920 | 0.920 | 0.00001 | 100.00% | 2.000 | 46.01% |

| ARS | EHD | ARS value | ARS − EHD | (ARS/EHD) % | TP | ARS/TP (%) |
|---|---|---|---|---|---|---|
| 11 | 13.305 | 14.193 | 0.88764 | 106.67% | 2.000 | 709.63% |
| 12 | 6.369 | 9.557 | 3.18769 | 150.05% | 2.000 | 477.83% |
| 21 | 6.107 | 6.133 | 0.02637 | 100.43% | 2.000 | 306.65% |
| 22 | 5.061 | 5.512 | 0.45051 | 108.90% | 2.000 | 275.59% |
| 31 | 5.114 | 5.266 | 0.15137 | 102.96% | 4.100 | 128.43% |
| 32 | 4.841 | 4.934 | 0.09260 | 101.91% | 4.100 | 120.34% |
| 41 | 4.763 | 4.764 | 0.00126 | 100.03% | 2.713 | 175.61% |
| 42 | 5.345 | 5.442 | 0.09680 | 101.81% | 2.713 | 200.58% |
| 51 | 6.078 | 6.383 | 0.30476 | 105.01% | 4.300 | 148.43% |
| 52 | 5.749 | 5.814 | 0.06529 | 101.14% | 4.300 | 135.21% |
| 61 | 5.797 | 6.061 | 0.26397 | 104.55% | 2.000 | 303.03% |
| 62 | 5.813 | 5.850 | 0.03696 | 100.64% | 2.000 | 292.50% |

The following contents may be deduced from Table 3 and Table 4.

Values Related to Inflection Point of Second Embodiment
(Primary Reference Wavelength = 555 nm)

| | | | | | | | |
|---|---|---|---|---|---|---|---|
| HIF311 | 0 | HIF311/HOI | 0 | SGI311 | 0 | \|SGI311\|/ | 0 |
| | | | | | | (\|SGI311\| + TP3) | |

### The Third Embodiment (Embodiment 3)

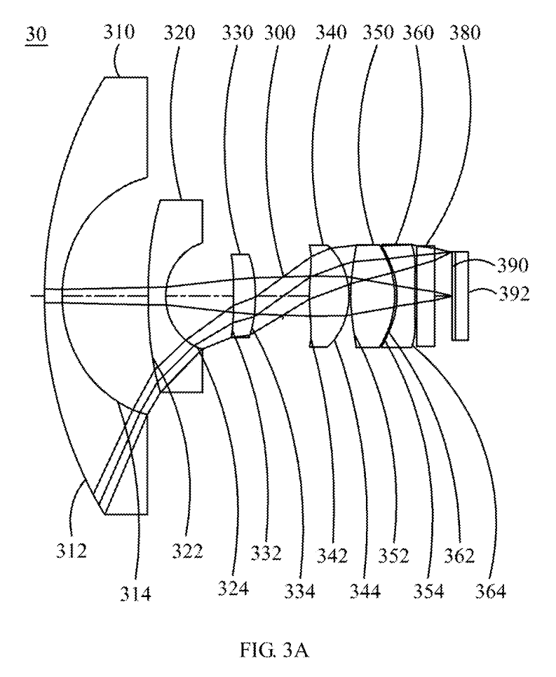

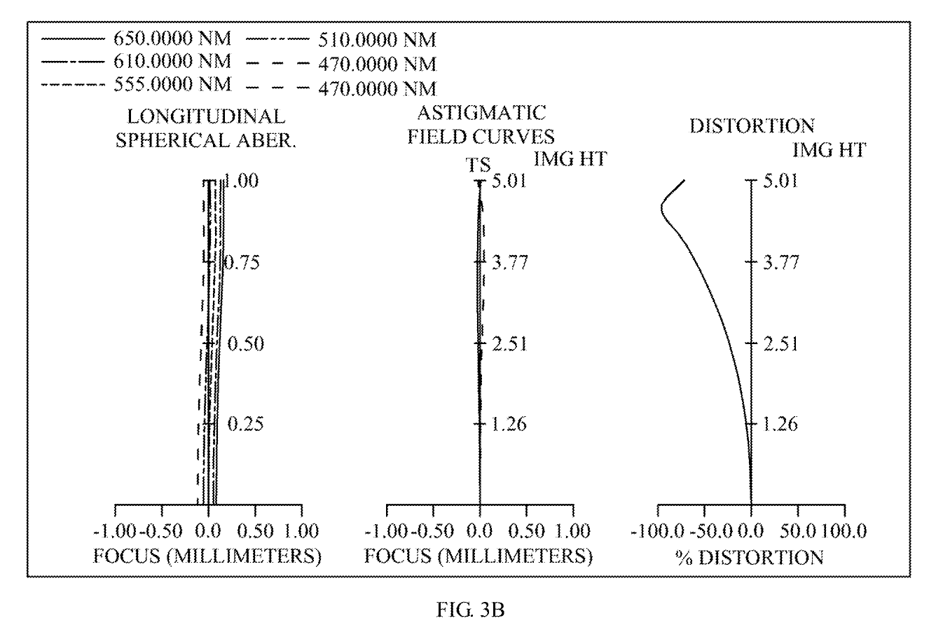

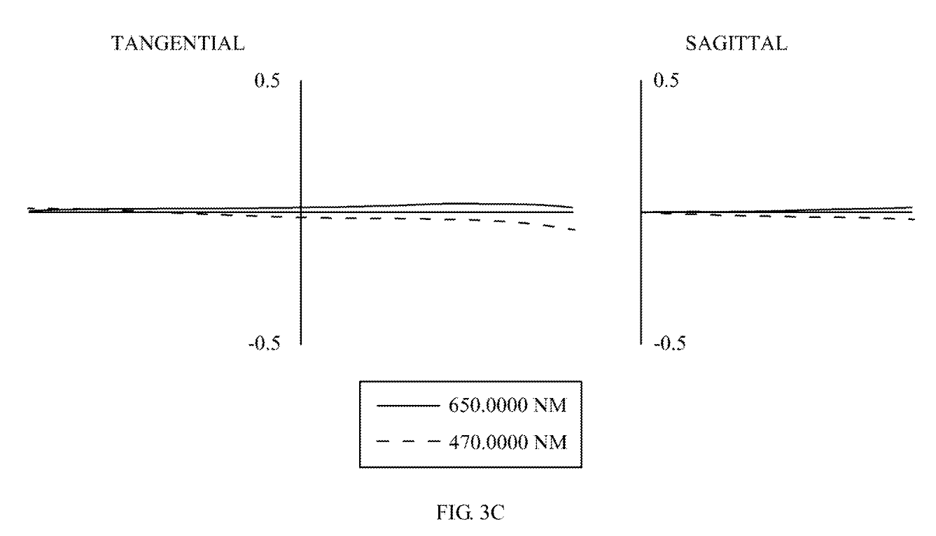

Please refer to FIG. 3A, FIG. 3B and FIG. 3C. FIG. 3A is a schematic view of the optical image capturing system according to the third embodiment of the present invention. FIG. 3B is longitudinal spherical aberration curves, astigmatic field curves, and an optical distortion curve of the optical image capturing system in the order from left to right according to the third embodiment of the present invention. FIG. 3C is a lateral aberration diagram of tangential fan, sagittal fan, the longest operation wavelength and the shortest operation wavelength passing through an edge of the entrance pupil and incident on the image plane by 0.7 HOI according to the third embodiment of the present invention. As shown in FIG. 3A, in order from an object side to an image side, the optical image capturing system 30 includes a first lens 310, a second lens 320, a third lens 330, an aperture stop 300, a fourth lens 340, a fifth lens 350, a sixth lens 360, an IR-bandstop filter 380, an image plane 390, and an image sensing device 392.

The first lens 310 has negative refractive power and is made of glass. The first lens 310 has a convex object side 312 and a concave image side 314. Both of the object side 312 and the image side 314 of the first lens 310 are spherical.

The second lens 320 has negative refractive power and is made of plastic. The second lens 320 has a convex object side 322 and a concave image side 324. Both of the object side 322 and the image side 324 of the second lens 320 are aspheric.

The third lens 330 has positive refractive power and is made of plastic. The third lens 330 has a concave object side 332 and a convex image side 334. Both of the object side 332 and the image side 334 of the third lens 330 are aspheric.

The fourth lens 340 has positive refractive power and is made of plastic. The fourth lens 340 has a convex object side 342 and a convex image side 344. Both of the object side 342 and the image side 344 of the fourth lens 340 are aspheric. The object side 342 of the fourth lens 340 has one inflection point.

The fifth lens 350 has positive refractive power and is made of plastic. The fifth lens 350 has a convex object side 352 and a convex image side 354. Both of the object side 352 and the image side 354 of the fifth lens 350 are aspheric. The object side 352 of the fifth lens 350 has one inflection point.

The sixth lens 360 has negative refractive power and is made of plastic. The sixth lens 360 has a concave object side 362 and a concave image side 364. Both of the object side 362 and the image side 364 of the sixth lens 360 are aspheric. The image side 364 of the sixth lens 360 has one inflection point. Hereby, the back focal length is reduced to miniaturize the lens effectively. In addition, the angle of incident with incoming light from an off-axis view field can be suppressed effectively and the aberration in the off-axis view field can be corrected further.

The IR-bandstop filter 380 is made of glass without affecting the focal length f of the optical image capturing system 30 and is disposed between the sixth lens 360 and the image plane 390.

Please refer to the following Table 5 and Table 6.

The detailed data of the optical image capturing system 30 of the third embodiment is as shown in Table 5.

TABLE 5
Lens Parameter for the Third Embodiment
f (focal length) = 3.35107 mm; f/HEP = 2.4;
HAF (half angle of view) = 100 deg

| Surface No. | Curvature Radius | | Thickness (mm) | Material |
|---|---|---|---|---|
| 0 | Object | 1E+18 | 1E+18 | |
| 1 | First Lens | 39.94985664 | 2.000 | Glass |
| 2 | | 12.42460758 | 9.753 | |
| 3 | Second Lens | 47.08888977 | 2.000 | Plastic |
| 4 | | 5.607047528 | 7.675 | |
| 5 | Third Lens | −127.6810996 | 2.483 | Plastic |
| 6 | | −14.92898044 | 3.138 | |
| 7 | Aperture | 1E+18 | 2.989 | |
| 8 | Fourth Lens | 18.93168536 | 4.476 | Plastic |
| 9 | | −6.97588396 | 0.200 | |
| 10 | Fifth Lens | 15.82841812 | 4.999 | Plastic |
| 11 | | −8.11091021 | 0.269 | |
| 12 | Sixth Lens | −6.660991145 | 2.000 | Plastic |
| 13 | | 49.91282791 | 0.234 | |
| 14 | IR-bandstop | 1E+18 | 2.000 | BK_7 |
| | Filter | | | |
| 15 | | 1E+18 | 1.999 | |
| 16 | Image Plane | 1E+18 | 0.000 | |

| Surface No. | Refractive Index | Coefficient of Dispersion | Focal Length |
|---|---|---|---|
| 0 | | | |
| 1 | 1.569 | 56.04 | −32.4558 |
| 2 | | | |
| 3 | 1.544 | 55.96 | −11.8642 |
| 4 | | | |
| 5 | 1.661 | 20.40 | 25.132 |
| 6 | | | |
| 7 | | | |
| 8 | 1.544 | 55.96 | 9.94678 |
| 9 | | | |
| 10 | 1.544 | 55.96 | 10.6082 |
| 11 | | | |
| 12 | 1.661 | 20.40 | −8.69042 |
| 13 | | | |
| 14 | 1.517 | 64.13 | |
| 15 | | | |
| 16 | | | |

Reference Wavelength = 555 nm;
Shield Position: the 9st surface with effective aperture radius = 5.200 mm

As for the parameters of the aspheric surfaces of the third embodiment, reference is made to Table 6.

TABLE 6
Aspheric Coefficients

| | Surface No. | | | |
|---|---|---|---|---|
| | 1 | 2 | 3 | 4 |
| k | 0.000000E+00 | 0.000000E+00 | 0.000000E+00 | 0.000000E+00 |
| A4 | 0.000000E+00 | 0.000000E+00 | 3.866442E−05 | −2.388756E−05 |
| A6 | 0.000000E+00 | 0.000000E+00 | 0.000000E+00 | 0.000000E+00 |
| A8 | 0.000000E+00 | 0.000000E+00 | 0.000000E+00 | 0.000000E+00 |
| A10 | 0.000000E+00 | 0.000000E+00 | 0.000000E+00 | 0.000000E+00 |
| | Surface No. | | | |
| | 5 | 6 | 8 | 9 |
| k | 0.000000E+00 | 0.000000E+00 | 0.000000E+00 | 0.000000E+00 |
| A4 | −5.775440E−04 | −3.696774E−04 | −9.809135E−04 | −1.389221E−04 |
| A6 | 0.000000E+00 | 0.000000E+00 | 0.000000E+00 | 0.000000E+00 |
| A8 | 0.000000E+00 | 0.000000E+00 | 0.000000E+00 | 0.000000E+00 |
| A10 | 0.000000E+00 | 0.000000E+00 | 0.000000E+00 | 0.000000E+00 |
| | Surface No. | | | |
| | 10 | 11 | 12 | 13 |
| k | 0.000000E+00 | 0.000000E+00 | 0.000000E+00 | 0.000000E+00 |
| A4 | −3.194411E−04 | 2.496154E−04 | 8.851249E−04 | −7.253515E−04 |
| A6 | 0.000000E+00 | 0.000000E+00 | 2.117052E−06 | −3.624906E−06 |
| A8 | 0.000000E+00 | 0.000000E+00 | 0.000000E+00 | 0.000000E+00 |
| A10 | 0.000000E+00 | 0.000000E+00 | 0.000000E+00 | 0.000000E+00 |

The presentation of the aspheric surface formula in the third embodiment is similar to that in the first embodiment. Furthermore, the definitions of the parameters in following tables are equal to those in the first embodiment so the repetitious details will not be given here.

The following contents may be deduced from Table 5 and Table 6.

Third Embodiment (Primary reference wavelength = 555 nm)

| \|f/f1\| | \|f/f2\| | \|f/f3\| | \|f/f4\| | \|f/f5\| | \|f/f6\| |
|---|---|---|---|---|---|
| 0.10325 | 0.28245 | 0.13334 | 0.33690 | 0.31589 | 0.38561 |
| | | ΣPPR/ | | | TP4/ |
| ΣPPR | ΣNPR | \|ΣNPR\| | IN12/f | IN56/f | (IN34 + TP4 + IN45) |
| 0.47024 | 0.90465 | 0.51980 | 2.91035 | 0.08042 | 0.41433 |
| \|f1/f2\| | \|f2/f3\| | (TP1 + IN12)/TP2 | | (TP6 + IN56)/TP5 | |
| 2.73561 | 0.47208 | 5.87640 | | 0.45401 | |
| HOS | InTL | HOS/HOI | InS/HOS | ODT % | TDT % |
| 46.21430 | 41.98130 | 9.24286 | 0.41472 | −124.90200 | 90.10600 |
| HVT51 | HVT52 | HVT61 | HVT62 | HVT62/HOI | HVT62/HOS |
| 0 | 0 | 0 | 2.56691 | 0.51338 | 0.05554 |
| TP2/TP3 | TP3/TP4 | InRS61 | InRS62 | \|InRS61\|/TP6 | \|InRS62\|/TP6 |
| 0.80563 | 0.55463 | −2.37135 | −1.14781 | 1.18568 | 0.57391 |
| PSTA | PLTA | NSTA | NLTA | SSTA | SLTA |
| −0.066 mm | 0.018 mm | 0.015 mm | 0.005 mm | −0.027 mm | 0.017 mm |

The numerical data related to the length of the outline curve is shown according to table 5 and table 6.

Third Embodiment (Primary reference wavelength = 555 nm)

| ARE | ½(HEP) | ARE value | ARE − ½(HEP) | 2(ARE/HEP) % | TP | ARE/TP (%) |
|---|---|---|---|---|---|---|
| 11 | 0.698 | 0.698 | −0.00010 | 99.99% | 2.000 | 34.90% |
| 12 | 0.698 | 0.698 | 0.00023 | 100.03% | 2.000 | 34.92% |
| 21 | 0.698 | 0.698 | −0.00011 | 99.98% | 2.000 | 34.90% |
| 22 | 0.698 | 0.700 | 0.00168 | 100.24% | 2.000 | 34.99% |
| 31 | 0.698 | 0.698 | −0.00014 | 99.98% | 2.483 | 28.12% |
| 32 | 0.698 | 0.698 | 0.00012 | 100.02% | 2.483 | 28.13% |
| 41 | 0.698 | 0.698 | 0.00001 | 100.00% | 4.476 | 15.60% |
| 42 | 0.698 | 0.699 | 0.00103 | 100.15% | 4.476 | 15.62% |
| 51 | 0.698 | 0.698 | 0.00008 | 100.01% | 4.999 | 13.97% |
| 52 | 0.698 | 0.699 | 0.00072 | 100.10% | 4.999 | 13.98% |
| 61 | 0.698 | 0.699 | 0.00113 | 100.16% | 2.000 | 34.96% |
| 62 | 0.698 | 0.698 | −0.00012 | 99.98% | 2.000 | 34.90% |

| ARS | EHD | ARS value | ARS − EHD | (ARS/EHD) % | TP | ARS/TP (%) |
|---|---|---|---|---|---|---|
| 11 | 26.697 | 29.237 | 2.54006 | 109.51% | 2.000 | 1461.84% |
| 12 | 12.419 | 19.111 | 6.69244 | 153.89% | 2.000 | 955.57% |
| 21 | 12.119 | 12.485 | 0.36642 | 103.02% | 2.000 | 624.26% |
| 22 | 5.605 | 8.637 | 3.03174 | 154.09% | 2.000 | 431.86% |
| 31 | 4.857 | 4.891 | 0.03383 | 100.70% | 2.483 | 197.01% |
| 32 | 4.668 | 4.797 | 0.12915 | 102.77% | 2.483 | 193.23% |
| 41 | 4.277 | 4.283 | 0.00548 | 100.13% | 4.476 | 95.69% |
| 42 | 5.200 | 5.929 | 0.72945 | 114.03% | 4.476 | 132.47% |
| 51 | 5.891 | 5.946 | 0.05532 | 100.94% | 4.999 | 118.95% |
| 52 | 6.040 | 6.624 | 0.58441 | 109.68% | 4.999 | 132.51% |
| 61 | 5.949 | 6.578 | 0.62867 | 110.57% | 2.000 | 328.88% |
| 62 | 6.684 | 7.038 | 0.35445 | 105.30% | 2.000 | 351.90% |

The following contents may be deduced from Table 5 and Table 6.

Values Related to Inflection Point of Third Embodiment
(Primary Reference Wavelength = 555 nm)

| | | | | | | | |
|---|---|---|---|---|---|---|---|
| HIF411 | 2.1390 | HIF411/ | 0.4278 | SGI411 | 0.1007 | \|SGI411\|/ | 0.0220 |
| | | HOI | | | | (\|SGI411\| + TP4) | |
| HIF511 | 4.2998 | HIF511/ | 0.8600 | SGI511 | 0.4860 | \|SGI511\|/ | 0.0886 |
| | | HOI | | | | (\|SGI511\| + TP5) | |
| HIF621 | 1.4976 | HIF621/ | 0.2995 | SGI621 | 0.0188 | \|SGI621\|/ | 0.0093 |
| | | HOI | | | | (\|SGI621\| + TP6) | |

### The Fourth Embodiment (Embodiment 4)

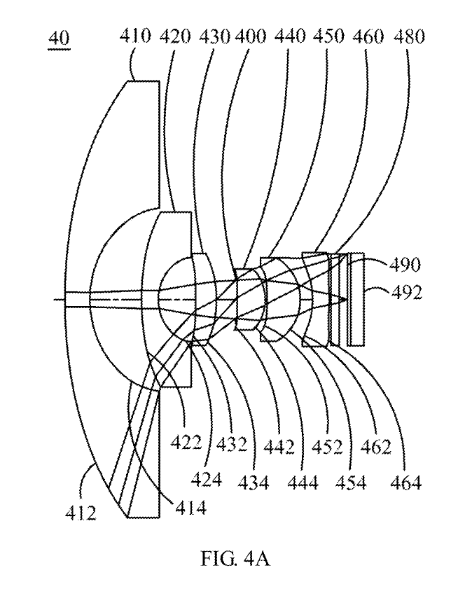

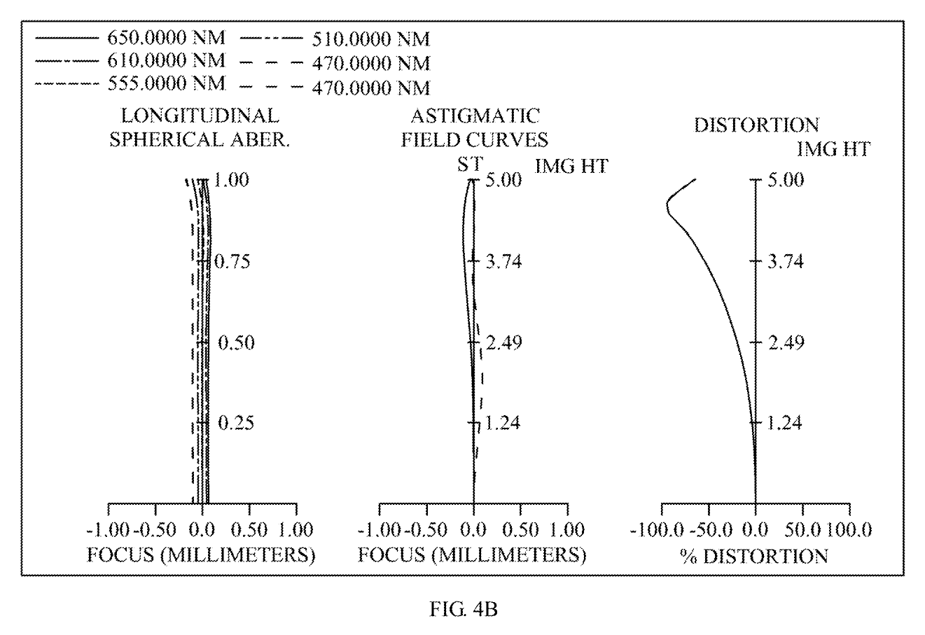

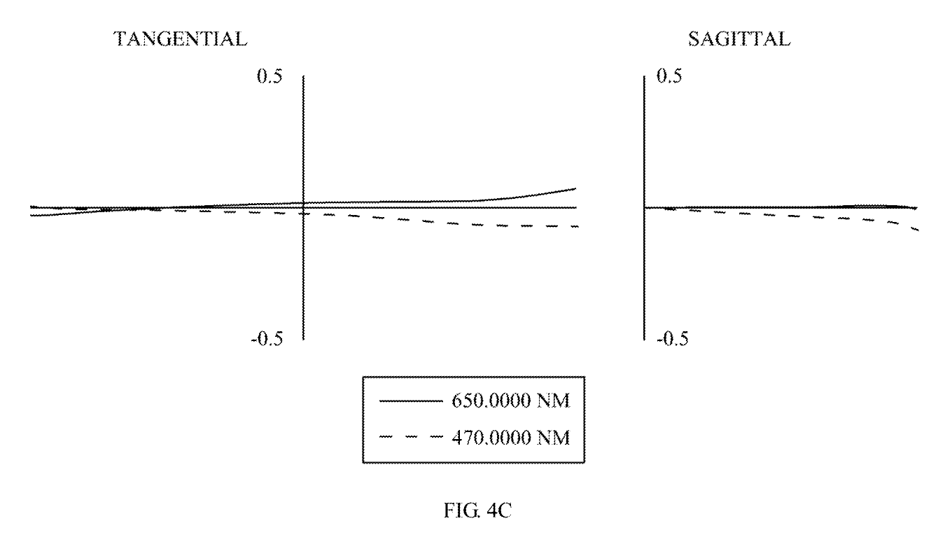

Please refer to FIG. 4A, FIG. 4B and FIG. 4C. FIG. 4A is a schematic view of the optical image capturing system according to the fourth embodiment of the present invention. FIG. 4B is longitudinal spherical aberration curves, astigmatic field curves, and an optical distortion curve of the optical image capturing system in the order from left to right according to the fourth embodiment of the present invention. FIG. 4C is a lateral aberration diagram of tangential fan, sagittal fan, the longest operation wavelength and the shortest operation wavelength passing through an edge of the entrance pupil and incident on the image plane by 0.7 HOI according to the fourth embodiment of the present invention. As shown in FIG. 4A, in order from an object side to an image side, the optical image capturing system 40 includes a first lens 410, a second lens 420, a third lens 430, an aperture stop 400, a fourth lens 440, a fifth lens 450, a sixth lens 460, an IR-bandstop filter 480, an image plane 490, and an image sensing device 492.

The first lens 410 has negative refractive power and is made of glass. The first lens 410 has a convex object side 412 and a concave image side 414. Both of the object side 412 and the image side 414 of the first lens 410 are aspheric.

The second lens 420 has negative refractive power and is made of glass. The second lens 420 has a convex object side 422 and a concave image side 424.

The third lens 430 has positive refractive power and is made of plastic. The third lens 430 has a concave object side 432 and a convex image side 434. Both of the object side 432 and the image side 434 of the third lens 430 are aspheric.

The fourth lens 440 has positive refractive power and is made of plastic. The fourth lens 440 has a convex object side 442 and a convex image side 444. Both of the object side 442 and the image side 444 of the fourth lens 440 are aspheric. The object side 442 of the fourth lens 440 has one inflection point.

The fifth lens 450 has positive refractive power and is made of plastic. The fifth lens 450 has a concave object side 452 and a convex image side 454. Both of the object side 452 and the image side 454 of the fifth lens 450 are aspheric.

The sixth lens 460 has negative refractive power and is made of plastic. The sixth lens 460 has a concave object side 462 and a convex image side 464. Both of the object side 462 and the image side 464 of the sixth lens 460 are aspheric. Both of the object side 462 and the image side 464 of the sixth lens 460 have one inflection point. Hereby, the back focal length is reduced to miniaturize the lens effectively. In addition, the angle of incident with incoming light from an off-axis view field can be suppressed effectively and the aberration in the off-axis view field can be corrected further.

The IR-bandstop filter 480 is made of glass without affecting the focal length f of the optical image capturing system 40 and is disposed between the sixth lens 460 and the image plane 490.

Please refer to the following Table 7 and Table 8.

The detailed data of the optical image capturing system 40 of the fourth embodiment is as shown in Table 7.

TABLE 7
Lens Parameter for the Fourth Embodiment
f (focal length) = 2.569 mm; f/HEP = 1.6;
HAF (half angle of view) = 100 deg

| Surface No. | Curvature Radius | | Thickness (mm) | Material |
|---|---|---|---|---|
| 0 | Object | 1E+18 | 1E+18 | |
| 1 | First Lens | 49.92672093 | 3.000 | Glass |
| 2 | | 10.04111694 | 6.229 | |
| 3 | Second Lens | 28.50882066 | 2.000 | Glass |
| 4 | | 4.580587029 | 4.492 | |
| 5 | Third Lens | −74.59269543 | 2.514 | Plastic |
| 6 | | −10.53575566 | 2.262 | |
| 7 | Aperture | 1E+18 | 0.200 | |
| 8 | Fourth Lens | 53.33909086 | 3.403 | Plastic |
| 9 | | −4.48113123 | 0.200 | |
| 10 | Fifth Lens | −63.54302117 | 4.000 | Plastic |
| 11 | | −5.104197728 | 1.501 | |
| 12 | Sixth Lens | −7.323708482 | 2.000 | Plastic |
| 13 | | −15.0381441 | 0.200 | |
| 14 | IR-bandstop | 1E+18 | 1.000 | BK_7 |
| | Filter | | | |
| 15 | | 1E+18 | 1.000 | |
| 16 | Image Plane | 1E+18 | 0.000 | |

| Surface No. | Refractive Index | Coefficient of Dispersion | Focal Length |
|---|---|---|---|
| 0 | | | |
| 1 | 1.497 | 81.56 | −25.8747 |
| 2 | | | |
| 3 | 1.658 | 50.85 | −8.54302 |
| 4 | | | |
| 5 | 1.661 | 20.40 | 18.1148 |
| 6 | | | |
| 7 | | | |
| 8 | 1.544 | 55.96 | 7.73499 |
| 9 | | | |
| 10 | 1.544 | 55.96 | 9.92909 |
| 11 | | | |
| 12 | 1.661 | 20.40 | −23.8879 |
| 13 | | | |
| 14 | 1.517 | 64.13 | |
| 15 | | | |
| 16 | | | |

Reference Wavelength = 555 nm

As for the parameters of the aspheric surfaces of the fourth embodiment, reference is made to Table 8.

TABLE 8
Aspheric Coefficients

| | Surface No. | | | |
|---|---|---|---|---|
| | 1 | 2 | 3 | 4 |
| k | −5.599750E−02 | 0.000000E+00 | 0.000000E+00 | 0.000000E+00 |
| A4 | 4.982519E−06 | −7.194333E−05 | 9.910379E−05 | −1.210585E−04 |
| A6 | −2.385092E−10 | 2.867405E−07 | −2.286001E−07 | −3.079038E−05 |
| A8 | 0.000000E+00 | 0.000000E+00 | 0.000000E+00 | 0.000000E+00 |
| A10 | 0.000000E+00 | 0.000000E+00 | 0.000000E+00 | 0.000000E+00 |
| | Surface No. | | | |
| | 5 | 6 | 8 | 9 |
| k | 0.000000E+00 | 0.000000E+00 | 0.000000E+00 | 0.000000E+00 |
| A4 | −9.725400E−04 | −4.654417E−05 | −1.088150E−03 | 6.109066E−04 |
| A6 | 1.577310E−05 | −1.381477E−06 | −2.262930E−04 | −8.275311E−05 |
| A8 | 0.000000E+00 | 0.000000E+00 | 0.000000E+00 | 0.000000E+00 |
| A10 | 0.000000E+00 | 0.000000E+00 | 0.000000E+00 | 0.000000E+00 |
| | Surface No. | | | |
| | 10 | 11 | 12 | 13 |
| k | 0.000000E+00 | 0.000000E+00 | 1.000000E+00 | −1.452399E+00 |
| A4 | −2.297770E−03 | −1.019769E−03 | 1.733632E−04 | 4.800351E−03 |
| A6 | −1.594923E−04 | 4.179094E−05 | 6.689039E−05 | −2.237145E−04 |
| A8 | 0.000000E+00 | 0.000000E+00 | 0.000000E+00 | 2.674459E−06 |
| A10 | 0.000000E+00 | 0.000000E+00 | 0.000000E+00 | 0.000000E+00 |

The presentation of the aspheric surface formula in the fourth embodiment is similar to that in the first embodiment. Furthermore, the definitions of the parameters in following tables are equal to those in the first embodiment so the repetitious details will not be given here.

The following contents may be deduced from Table 7 and Table 8.

Fourth Embodiment (Primary reference wavelength = 555 nm)

| \|f/f1\| | \|f/f2\| | \|f/f3\| | \|f/f4\| | \|f/f5\| | \|f/f6\| |
|---|---|---|---|---|---|
| 0.09928 | 0.30070 | 0.14181 | 0.33211 | 0.25872 | 0.10754 |
| | | | | | TP4/ |
| ΣPPR | ΣNPR | ΣPPR/\|ΣNPR\| | IN12/f | IN56/f | (IN34 + TP4 + IN45) |
| 1.10978 | 0.39998 | 2.77458 | 2.42467 | 0.58441 | 0.56108 |
| \|f1/f2\| | \|f2/f3\| | (TP1 + IN12)/TP2 | | (TP6 + IN56)/TP5 | |
| 3.02875 | 0.47160 | 4.61434 | | 0.87533 | |
| HOS | InTL | HOS/HOI | InS/HOS | ODT % | TDT % |
| 34.00040 | 31.80100 | 6.80008 | 0.39716 | −133.30700 | 102.49700 |
| HVT51 | HVT52 | HVT61 | HVT62 | HVT62/HOI | HVT62/HOS |
| 0 | 0 | 0 | 0 | 0 | 0 |
| TP2/TP3 | TP3/TP4 | InRS61 | InRS62 | \|InRS61\|/TP6 | \|InRS62\|/TP6 |
| 0.79550 | 0.73880 | −1.21273 | −0.25003 | 0.60637 | 0.12501 |
| PSTA | PLTA | NSTA | NLTA | SSTA | SLTA |
| −0.071 mm | 0.071 mm | 0.005 mm | −0.030 mm | −0.084 mm | −0.004 mm |

The numerical data related to the length of the outline curve is shown according to table 7 and table 8.

Fourth Embodiment (Primary reference wavelength = 555 nm)

| ARE | ½(HEP) | ARE value | ARE − ½(HEP) | 2(ARE/HEP) % | TP | ARE/TP (%) |
|---|---|---|---|---|---|---|
| 11 | 0.803 | 0.802 | −0.00074 | 99.91% | 3.000 | 26.73% |
| 12 | 0.803 | 0.803 | 0.00008 | 100.01% | 3.000 | 26.76% |
| 21 | 0.803 | 0.802 | −0.00067 | 99.92% | 2.000 | 40.11% |
| 22 | 0.803 | 0.806 | 0.00337 | 100.42% | 2.000 | 40.31% |
| 31 | 0.803 | 0.802 | −0.00076 | 99.91% | 2.514 | 31.90% |
| 32 | 0.803 | 0.803 | 0.00000 | 100.00% | 2.514 | 31.93% |
| 41 | 0.803 | 0.802 | −0.00075 | 99.91% | 3.403 | 23.57% |
| 42 | 0.803 | 0.806 | 0.00353 | 100.44% | 3.403 | 23.69% |
| 51 | 0.803 | 0.802 | −0.00074 | 99.91% | 4.000 | 20.05% |
| 52 | 0.803 | 0.805 | 0.00261 | 100.33% | 4.000 | 20.13% |
| 61 | 0.803 | 0.804 | 0.00084 | 100.10% | 2.000 | 40.18% |
| 62 | 0.803 | 0.802 | −0.00047 | 99.94% | 2.000 | 40.12% |

| ARS | EHD | ARS value | ARS − EHD | (ARS/EHD) % | TP | ARS/TP (%) |
|---|---|---|---|---|---|---|
| 11 | 23.948 | 25.658 | 1.70967 | 107.14% | 3.000 | 855.25% |
| 12 | 9.972 | 14.264 | 4.29190 | 143.04% | 3.000 | 475.46% |
| 21 | 9.606 | 10.013 | 0.40694 | 104.24% | 2.000 | 500.66% |
| 22 | 4.576 | 6.688 | 2.11237 | 146.16% | 2.000 | 334.41% |
| 31 | 4.562 | 4.594 | 0.03201 | 100.70% | 2.514 | 182.74% |
| 32 | 4.362 | 4.506 | 0.14422 | 103.31% | 2.514 | 179.24% |
| 41 | 2.266 | 2.266 | −0.00005 | 100.00% | 3.403 | 66.58% |
| 42 | 3.316 | 3.760 | 0.44323 | 113.36% | 3.403 | 110.48% |
| 51 | 3.569 | 3.767 | 0.19740 | 105.53% | 4.000 | 94.17% |
| 52 | 4.553 | 5.651 | 1.09790 | 124.12% | 4.000 | 141.27% |
| 61 | 4.525 | 4.726 | 0.20130 | 104.45% | 2.000 | 236.31% |
| 62 | 5.023 | 5.060 | 0.03679 | 100.73% | 2.000 | 253.00% |

The following contents may be deduced from Table 7 and Table 8.

Values Related to Inflection Point of fourth Embodiment
(Primary Reference Wavelength = 555 nm)

| | | | | | | | |
|---|---|---|---|---|---|---|---|
| HIF411 | 3.8336 | HIF411/ | 0.9880 | SGI411 | 1.1104 | \|SGI411\|/ | 0.2339 |
| | | HOI | | | | (\|SGI411\| + TP4) | |
| HIF611 | 3.6354 | HIF611/ | 0.7271 | SGI611 | −0.8693 | \|SGI611\|/ | 0.3030 |
| | | HOI | | | | (\|SGI611\| + TP6) | |
| HIF612 | 4.1175 | HIF612/ | 0.8235 | SGI612 | −1.0652 | \|SGI612\|/ | 0.3475 |
| | | HOI | | | | (\|SGI612\| + TP6) | |
| HIF621 | 1.1655 | HIF621/ | 0.2331 | SGI621 | −0.0368 | \|SGI621\|/ | 0.0181 |
| | | HOI | | | | (\|SGI621\| + TP6) | |
| HIF622 | 3.1109 | HIF622/ | 0.6222 | SGI622 | −0.0500 | \|SGI622\|/ | 0.0244 |
| | | HOI | | | | (\|SGI622\| + TP6) | |

### The Fifth Embodiment (Embodiment 5)

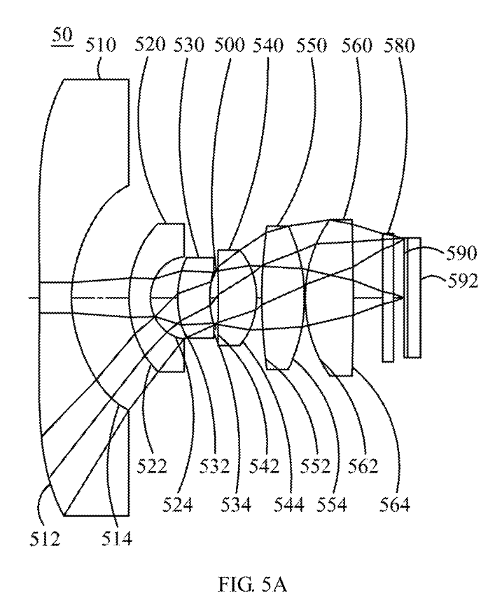

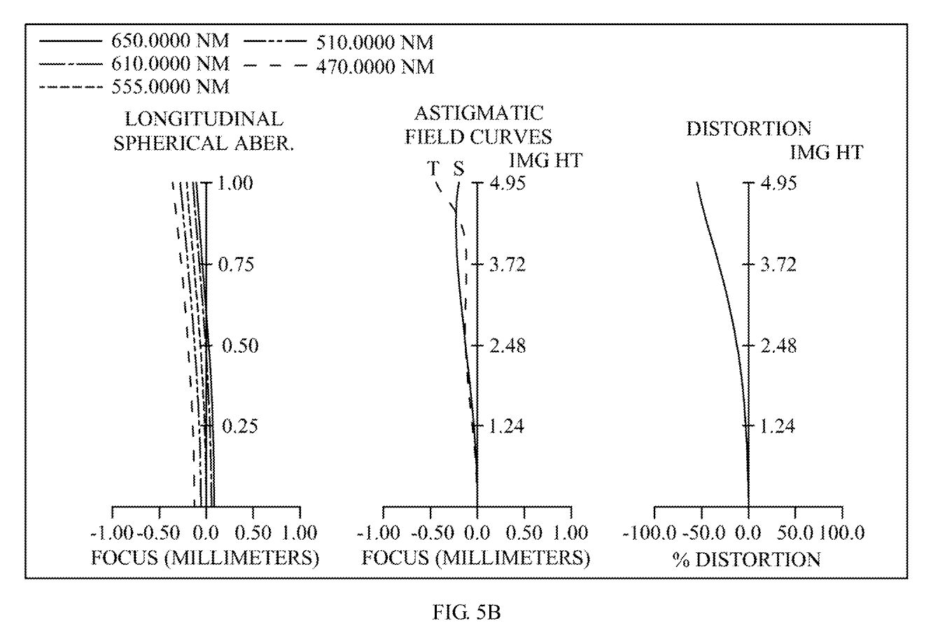

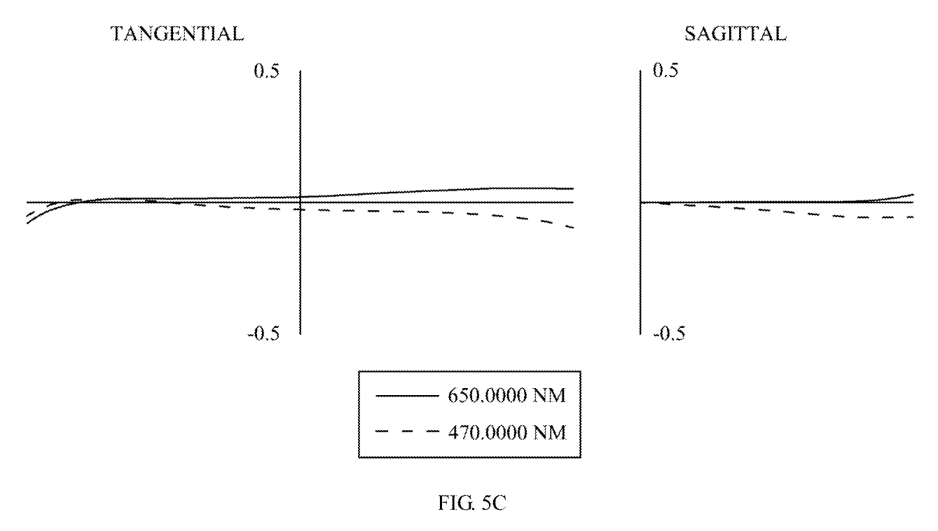

Please refer to FIG. 5A, FIG. 5B and FIG. 5C. FIG. 5A is a schematic view of the optical image capturing system according to the fifth embodiment of the present invention. FIG. 5B is longitudinal spherical aberration curves, astigmatic field curves, and an optical distortion curve of the optical image capturing system in the order from left to right according to the fifth embodiment of the present invention. FIG. 5C is a lateral aberration diagram of tangential fan, sagittal fan, the longest operation wavelength and the shortest operation wavelength passing through an edge of the entrance pupil and incident on the image plane by 0.7 HOI according to the fifth embodiment of the present invention. As shown in FIG. 5A, in order from an object side to an image side, the optical image capturing system 50 includes a first lens 510, a second lens 520, a third lens 530, an aperture stop 500, a fourth lens 540, a fifth lens 550, a sixth lens 560, an IR-bandstop filter 580, an image plane 590, and an image sensing device 592.

The first lens 510 has negative refractive power and is made of glass. The first lens 510 has a concave object side 512 and a concave image side 514. Both of the object side 512 and the image side 514 of the first lens 510 are aspheric. The object side 512 of the first lens 510 has one inflection point.

The second lens 520 has negative refractive power and is made of glass. The second lens 520 has a convex object side 522 and a concave image side 524. Both of the object side 522 and the image side 524 of the second lens 520 are spherical.

The third lens 530 has positive refractive power and is made of glass. The third lens 530 has a convex object side 532 and a concave image side 534. Both of the object side 532 and the image side 534 of the third lens 530 are spherical.

The fourth lens 540 has positive refractive power and is made of glass. The fourth lens 540 has a concave object side 542 and a convex image side 544. Both of the object side 542 and the image side 544 of the fourth lens 540 are spherical.

The fifth lens 550 has positive refractive power and is made of glass. The fifth lens 550 has a convex object side 552 and a convex image side 554. Both of the object side 552 and the image side 554 of the fifth lens 550 are spherical.

The sixth lens 560 has positive refractive power and is made of plastic. The sixth lens 560 has a convex object side 562 and a convex image side 564. Both of the object side 562 and the image side 564 of the sixth lens 560 are spherical. Hereby, the back focal length is reduced to miniaturize the lens effectively. In addition, the angle of incident with incoming light from an off-axis view field can be suppressed effectively and the aberration in the off-axis view field can be corrected further.

The IR-bandstop filter 580 is made of glass without affecting the focal length f of the optical image capturing system 50 and is disposed between the sixth lens 560 and the image plane 590.

Please refer to the following Table 9 and Table 10.

The detailed data of the optical image capturing system 50 of the fifth embodiment is as shown in Table 9.

TABLE 9
Lens Parameter for the Fifth Embodiment
f (focal length) = 4.077 mm; f/HEP = 1.6;
HAF (half angle of view) = 70 deg

| Surface No. | Curvature Radius | | Thickness (mm) | Material |
|---|---|---|---|---|
| 0 | Object | 1E+18 | 1E+18 | |
| 1 | First Lens | −285.4847192 | 3.000 | Glass |
| 2 | | 9.915511784 | 5.360 | |
| 3 | Second Lens | 8.520966112 | 2.000 | Glass |
| 4 | | 3.455512823 | 2.539 | |
| 5 | Third Lens | 7.345536924 | 3.000 | Glass |
| 6 | | 7.496148199 | 0.554 | |
| 7 | Aperture | 1E+18 | 0.224 | |
| 8 | Fourth Lens | −143.1264978 | 3.571 | Glass |
| 9 | | −5.87925421 | 0.490 | |
| 10 | Fifth Lens | 38.83261522 | 3.972 | Glass |
| 11 | | −12.58712249 | 0.081 | |
| 12 | Sixth Lens | 10.53263983 | 4.465 | Glass |
| 13 | | −200.0200003 | 2.745 | |
| 14 | IR-bandstop | 1E+18 | 1.000 | BK_7 |
| | Filter | | | |
| 15 | | 1E+18 | 1.000 | |
| 16 | Image Plane | 1E+18 | 0.000 | |

| Surface No. | Refractive Index | Coefficient of Dispersion | Focal Length |
|---|---|---|---|
| 0 | | | |
| 1 | 1.497 | 81.56 | −19.169 |
| 2 | | | |
| 3 | 1.553 | 71.68 | −12.197 |
| 4 | | | |
| 5 | 2.002 | 19.32 | 32.835 |
| 6 | | | |
| 7 | | | |
| 8 | 1.569 | 56.04 | 10.643 |
| 9 | | | |
| 10 | 1.569 | 56.04 | 17.138 |
| 11 | | | |
| 12 | 1.497 | 81.56 | 20.226 |
| 13 | | | |
| 14 | 1.517 | 64.13 | |
| 15 | | | |
| 16 | | | |

Reference Wavelength = 555 nm

As for the parameters of the aspheric surfaces of the fifth embodiment, reference is made to Table 10.

TABLE 10
Aspheric Coefficients

| | Surface No. | | | |
|---|---|---|---|---|
| | 1 | 2 | 3 | 4 |
| k | 0.000000E+00 | 0.000000E+00 | 0.000000E+00 | 0.000000E+00 |
| A4 | 2.230590E−05 | −2.186554E−04 | 0.000000E+00 | 0.000000E+00 |
| A6 | 9.869022E−09 | 3.286427E−07 | 0.000000E+00 | 0.000000E+00 |
| A8 | 0.000000E+00 | 0.000000E+00 | 0.000000E+00 | 0.000000E+00 |
| A10 | 0.000000E+00 | 0.000000E+00 | 0.000000E+00 | 0.000000E+00 |
| | Surface No. | | | |
| | 5 | 6 | 8 | 9 |
| k | 0.000000E+00 | 0.000000E+00 | 0.000000E+00 | 0.000000E+00 |
| A4 | 0.000000E+00 | 0.000000E+00 | 0.000000E+00 | 0.000000E+00 |
| A6 | 0.000000E+00 | 0.000000E+00 | 0.000000E+00 | 0.000000E+00 |
| A8 | 0.000000E+00 | 0.000000E+00 | 0.000000E+00 | 0.000000E+00 |
| A10 | 0.000000E+00 | 0.000000E+00 | 0.000000E+00 | 0.000000E+00 |
| | Surface No. | | | |
| | 10 | 11 | 12 | 13 |
| k | 0.000000E+00 | 0.000000E+00 | 0.000000E+00 | 0.000000E+00 |
| A4 | 0.000000E+00 | 0.000000E+00 | 0.000000E+00 | 0.000000E+00 |
| A6 | 0.000000E+00 | 0.000000E+00 | 0.000000E+00 | 0.000000E+00 |
| A8 | 0.000000E+00 | 0.000000E+00 | 0.000000E+00 | 0.000000E+00 |
| A10 | 0.000000E+00 | 0.000000E+00 | 0.000000E+00 | 0.000000E+00 |

The presentation of the aspheric surface formula in the fifth embodiment is similar to that in the first embodiment. Furthermore, the definitions of the parameters in following tables are equal to those in the first embodiment so the repetitious details will not be given here.

The following contents may be deduced from Table 9 and Table 10.

Fifth Embodiment (Primary reference wavelength = 555 nm)

| \|f/f1\| | \|f/f2\| | \|f/f3\| | \|f/f4\| | \|f/f5\| | \|f/f6\| |
|---|---|---|---|---|---|
| 0.21270 | 0.33429 | 0.12417 | 0.38309 | 0.23790 | 0.20159 |
| | | | | | TP4/ |
| ΣPPR | ΣNPR | ΣPPR/\|ΣNPR\| | IN12/f | IN56/f | (IN34 + TP4 + IN45) |
| 0.70886 | 0.78489 | 0.90313 | 1.31464 | 0.01984 | 0.73803 |
| \|f1/f2\| | \|f2/f3\| | (TP1 + IN12)/TP2 | | (TP6 + IN56)/TP5 | |
| 1.57165 | 0.37146 | 4.17990 | | 1.14460 | |
| HOS | InTL | HOS/HOI | InS/HOS | ODT % | TDT % |
| 34.00000 | 29.25490 | 6.80000 | 0.51611 | −54.89250 | 35.91980 |
| HVT51 | HVT52 | HVT61 | HVT62 | HVT62/HOI | HVT62/HOS |
| 0 | 0 | 0 | 0 | 0 | 0 |
| TP2/TP3 | TP3/TP4 | InRS61 | InRS62 | \|InRS61\|/TP6 | \|InRS62\|/TP6 |
| 0.66667 | 0.84022 | 2.27978 | −0.09567 | 0.51055 | 0.02143 |
| PSTA | PLTA | NSTA | NLTA | SSTA | SLTA |
| −0.096 mm | 0.053 mm | −0.050 mm | −0.079 mm | −0.056 mm | 0.028 mm |

The numerical data related to the length of the outline curve is shown according to table 9 and table 10.

Fifth Embodiment (Primary reference wavelength = 555 nm)

| | | | ARE − | | | |
|---|---|---|---|---|---|---|
| ARE | ½(HEP) | ARE value | ½(HEP) | 2(ARE/HEP) % | TP | ARE/TP (%) |
| 11 | 1.274 | 1.274 | −0.00013 | 99.99% | 3.000 | 42.47% |
| 12 | 1.274 | 1.277 | 0.00334 | 100.26% | 3.000 | 42.59% |
| 21 | 1.274 | 1.279 | 0.00466 | 100.37% | 2.000 | 63.94% |
| 22 | 1.274 | 1.305 | 0.03066 | 102.41% | 2.000 | 65.24% |
| 31 | 1.274 | 1.280 | 0.00635 | 100.50% | 3.000 | 42.68% |
| 32 | 1.274 | 1.280 | 0.00608 | 100.48% | 3.000 | 42.67% |
| 41 | 1.274 | 1.274 | −0.00011 | 99.99% | 3.571 | 35.68% |
| 42 | 1.274 | 1.284 | 0.01006 | 100.79% | 3.571 | 35.97% |
| 51 | 1.274 | 1.274 | 0.00010 | 100.01% | 3.972 | 32.08% |
| 52 | 1.274 | 1.276 | 0.00206 | 100.16% | 3.972 | 32.13% |
| 61 | 1.274 | 1.277 | 0.00300 | 100.24% | 4.465 | 28.60% |
| 62 | 1.274 | 1.274 | −0.00012 | 99.99% | 4.465 | 28.53% |
| ARS | EHD | ARS value | ARS − EHD | (ARS/EHD) % | TP | ARS/TP (%) |
| 11 | 18.312 | 18.698 | 0.38601 | 102.11% | 3.000 | 623.34% |
| 12 | 9.421 | 11.366 | 1.94443 | 120.64% | 3.000 | 378.90% |
| 21 | 6.219 | 6.970 | 0.75083 | 112.07% | 2.000 | 348.48% |
| 22 | 3.441 | 5.111 | 1.66992 | 148.53% | 2.000 | 255.55% |
| 31 | 3.370 | 3.500 | 0.13033 | 103.87% | 3.000 | 116.66% |
| 32 | 2.299 | 2.336 | 0.03684 | 101.60% | 3.000 | 77.85% |
| 41 | 2.587 | 2.586 | −0.00084 | 99.97% | 3.571 | 72.43% |
| 42 | 4.007 | 4.409 | 0.40128 | 110.01% | 3.571 | 123.48% |
| 51 | 5.461 | 5.479 | 0.01801 | 100.33% | 3.972 | 137.95% |
| 52 | 6.025 | 6.283 | 0.25717 | 104.27% | 3.972 | 158.18% |
| 61 | 6.543 | 7.059 | 0.51573 | 107.88% | 4.465 | 158.08% |
| 62 | 6.185 | 6.185 | 0.00047 | 100.01% | 4.465 | 138.51% |

The following contents may be deduced from Table 9 and Table 10.

Values Related to Inflection Point of fifth Embodiment
(Primary Reference Wavelength = 555 nm)

| | | | | | | | |
|---|---|---|---|---|---|---|---|
| HIF111 | 3.5923 | HIF111/ | 0.7185 | SGI111 | −0.0189 | \|SGI111\|/ | 0.0063 |
| | | HOI | | | | (\|SGI111\| + TP1) | |

### The Sixth Embodiment (Embodiment 6)

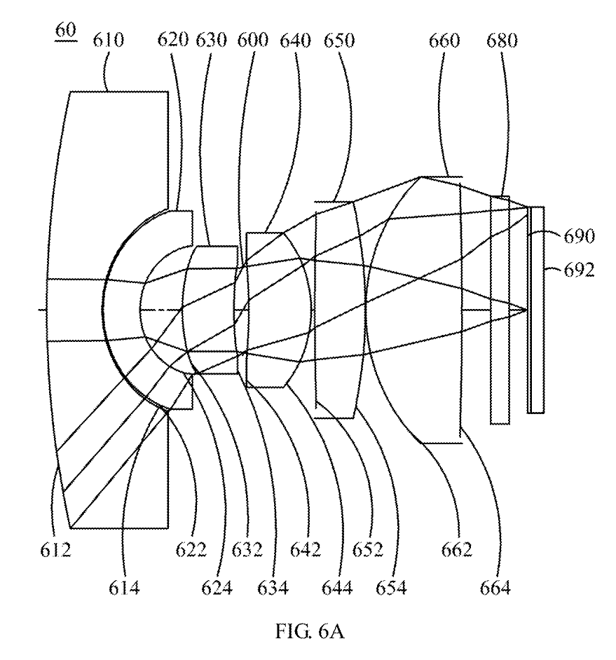

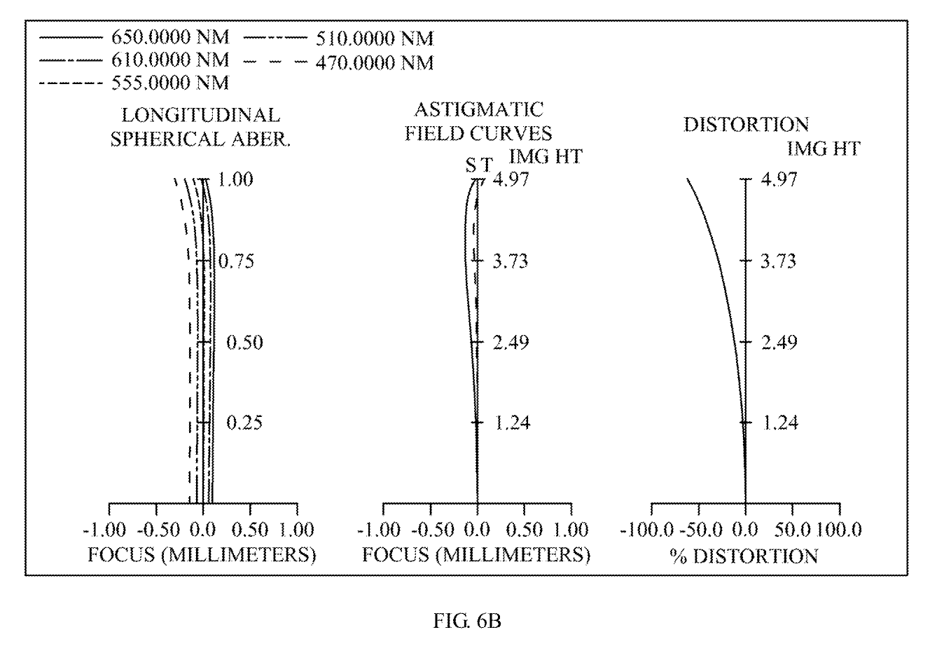

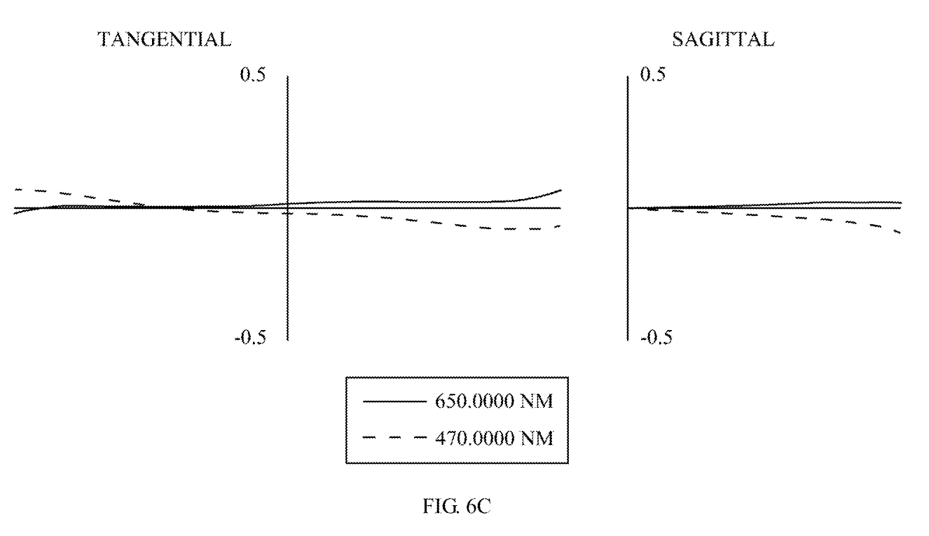

Please refer to FIG. 6A, FIG. 6B and FIG. 6C. FIG. 6A is a schematic view of the optical image capturing system according to the sixth Embodiment of the present invention. FIG. 6B is longitudinal spherical aberration curves, astigmatic field curves, and an optical distortion curve of the optical image capturing system in the order from left to right according to the sixth Embodiment of the present invention. FIG. 6C is a lateral aberration diagram of tangential fan, sagittal fan, the longest operation wavelength and the shortest operation wavelength passing through an edge of the entrance pupil and incident on the image plane by 0.7 HOI according to the sixth embodiment of the present invention. As shown in FIG. 6A, in order from an object side to an image side, the optical image capturing system 60 includes a first lens 610, a second lens 620, a third lens 630, an aperture stop 600, a fourth lens 640, a fifth lens 650, a sixth lens 660, an IR-bandstop filter 680, an image plane 690, and an image sensing device 692.

The first lens 610 has negative refractive power and is made of glass. The first lens 610 has a convex object side 612 and a concave image side 614. Both of the object side 612 and the image side 614 of the first lens 610 are spherical.

The second lens 620 has negative refractive power and is made of glass. The second lens 620 has a convex object side 622 and a concave image side 624. Both of the object side 622 and the image side 624 of the second lens 620 are spherical.

The third lens 630 has positive refractive power and is made of glass. The third lens 630 has a concave object side 632 and a convex image side 634. Both of the object side 632 and the image side 634 of the third lens 630 are aspheric.

The fourth lens 640 has positive refractive power and is made of glass. The fourth lens 640 has a concave object side 642 and a convex image side 644. Both of the object side 642 and the image side 644 of the fourth lens 640 are spherical.

The fifth lens 650 has positive refractive power and is made of glass. The fifth lens 650 has a convex object side 652 and a convex image side 654. Both of the object side 652 and the image side 654 of the fifth lens 650 are spherical.

The sixth lens 660 has positive refractive power and is made of glass. The sixth lens 660 has a convex object side 662 and a convex image side 664. Both of the object side 662 and the image side 664 of the sixth lens 660 are spherical. Hereby, the back focal length is reduced to miniaturize the lens effectively. In addition, the angle of incident with incoming light from an off-axis view field can be suppressed effectively and the aberration in the off-axis view field can be corrected further.

The IR-bandstop filter 680 is made of glass without affecting the focal length f of the optical image capturing system 60 and is disposed between the sixth lens 660 and the image plane 690.

Please refer to the following Table 11 and Table 12.

The detailed data of the optical image capturing system 60 of the sixth Embodiment is as shown in Table 11.

TABLE 11
Lens Parameter for the Sixth Embodiment
f (focal length) = 4.866 mm; f/HEP = 1.6;
HAF (half angle of view) = 70 deg

| Surface | | | | |
|---|---|---|---|---|
| No. | Curvature Radius | | Thickness (mm) | Material |
| 0 | Object | 1E+18 | 1E+18 | |
| 1 | First Lens | 44.9660633 | 2.999 | Glass |
| 2 | | 5.211415802 | 0.050 | |
| 3 | Second Lens | 5.032302116 | 2.000 | Glass |
| 4 | | 3.153145731 | 2.280 | |
| 5 | Third Lens | 8.0641139 | 2.797 | Glass |
| 6 | | 19.80167808 | 0.477 | |
| 7 | Aperture | 1E+18 | 0.325 | |
| 8 | Fourth Lens | −22.78279237 | 3.364 | Glass |
| 9 | | −5.473580879 | 0.200 | |
| 10 | Fifth Lens | 156.6630309 | 2.732 | Glass |
| 11 | | −21.5579582 | 0.025 | |
| 12 | Sixth Lens | 8.578963147 | 5.200 | Glass |
| 13 | | −200.021581 | 1.551 | |
| 14 | IR-bandstop | 1E+18 | 1.000 | BK_7 |
| | Filter | | | |
| 15 | | 1E+18 | 1.000 | |
| 16 | Image Plane | 1E+18 | 0.000 | |

| Surface No. | Refractive Index | Coefficient of Dispersion | Focal Length |
|---|---|---|---|
| 0 | | | |
| 1 | 1.497 | 81.56 | −12.135615 |
| 2 | | | |
| 3 | 2.002 | 19.32 | −17.964289 |
| 4 | | | |
| 5 | 1.923 | 20.88 | 13.110025 |
| 6 | | | |
| 7 | | | |
| 8 | 1.723 | 37.99 | 9.162113 |
| 9 | | | |
| 10 | 1.497 | 81.56 | 10.5601 |
| 11 | | | |
| 12 | 1.497 | 81.56 | 12.9841 |
| 13 | | | |
| 14 | 1.517 | 64.13 | |
| 15 | | | |
| 16 | | | |

Reference Wavelength = 555 nm

As for the parameters of the aspheric surfaces of the sixth Embodiment, reference is made to Table 12.

TABLE 12
Aspheric Coefficients

| | Surface No. | | | |
|---|---|---|---|---|
| | 1 | 2 | 3 | 4 |
| k | 0.000000E+00 | 0.000000E+00 | 0.000000E+00 | 0.000000E+00 |
| A4 | 0.000000E+00 | 0.000000E+00 | 0.000000E+00 | 0.000000E+00 |
| A6 | 0.000000E+00 | 0.000000E+00 | 0.000000E+00 | 0.000000E+00 |
| A8 | 0.000000E+00 | 0.000000E+00 | 0.000000E+00 | 0.000000E+00 |
| A10 | 0.000000E+00 | 0.000000E+00 | 0.000000E+00 | 0.000000E+00 |
| | Surface No. | | | |
| | 5 | 6 | 8 | 9 |
| k | 0.000000E+00 | 0.000000E+00 | 0.000000E+00 | 0.000000E+00 |
| A4 | 4.389446E−04 | 1.693160E−03 | 0.000000E+00 | 0.000000E+00 |
| A6 | 1.256058E−04 | 9.810560E−05 | 0.000000E+00 | 0.000000E+00 |
| A8 | 0.000000E+00 | 0.000000E+00 | 0.000000E+00 | 0.000000E+00 |
| A10 | 0.000000E+00 | 0.000000E+00 | 0.000000E+00 | 0.000000E+00 |
| | Surface No. | | | |
| | 10 | 11 | 12 | 13 |
| k | 0.000000E+00 | 0.000000E+00 | 0.000000E+00 | 0.000000E+00 |
| A4 | 0.000000E+00 | 0.000000E+00 | 0.000000E+00 | 0.000000E+00 |
| A6 | 0.000000E+00 | 0.000000E+00 | 0.000000E+00 | 0.000000E+00 |
| A8 | 0.000000E+00 | 0.000000E+00 | 0.000000E+00 | 0.000000E+00 |
| A10 | 0.000000E+00 | 0.000000E+00 | 0.000000E+00 | 0.000000E+00 |

In the sixth Embodiment, the presentation of the aspheric surface formula is similar to that in the first embodiment. Furthermore, the definitions of the parameters in following tables are equal to those in the first embodiment, so the repetitious details will not be given here.

The following contents may be deduced from Table 11 and Table 12.

Sixth Embodiment (Primary reference wavelength = 555 nm)

| \|f/f1\| | \|f/f2\| | \|f/f3\| | \|f/f4\| | \|f/f5\| | \|f/f6\| |
|---|---|---|---|---|---|
| 0.40098 | 0.27088 | 0.37118 | 0.53112 | 0.12729 | 0.29228 |
| | | ΣPPR/ | | | TP4/ |
| ΣPPR | ΣNPR | \|ΣNPR\| | IN12/f | IN56/f | (IN34 + TP4 + IN45) |
| 1.23117 | 0.67186 | 1.83247 | 0.01028 | 0.00514 | 0.77041 |
| \|f1/f2\| | \|f2/f3\| | (TP1 + IN12)/TP2 | | (TP6 + IN56)/TP5 | |
| 0.67554 | 1.37027 | 1.52445 | | 1.91286 | |
| HOS | InTL | HOS/HOI | InS/HOS | ODT % | TDT % |
| 26.00110 | 22.44970 | 5.20022 | 0.59219 | −62.13740 | 44.42730 |
| HVT51 | HVT52 | HVT61 | HVT62 | HVT62/HOI | HVT62/HOS |
| 0 | 0 | 0 | 0 | 0 | 0 |
| TP2/TP3 | TP3/TP4 | InRS61 | InRS62 | \|InRS61\|/TP6 | \|InRS62\|/TP6 |
| 0.71496 | 0.83151 | 2.97389 | −0.09230 | 0.57189 | 0.01775 |
| PSTA | PLTA | NSTA | NLTA | SSTA | SLTA |
| −0.067 mm | 0.067 mm | 0.071 mm | −0.020 mm | −0.092 mm | 0.020 mm |

The numerical data related to the length of the outline curve is shown according to table 11 and table 12.

Sixth Embodiment (Primary reference wavelength = 555 nm)

| | | | ARE − | | | |
|---|---|---|---|---|---|---|
| ARE | ½(HEP) | ARE value | ½(HEP) | 2(ARE/HEP) % | TP | ARE/TP (%) |
| 11 | 1.521 | 1.520 | −0.00041 | 99.97% | 2.999 | 50.69% |
| 12 | 1.521 | 1.542 | 0.02172 | 101.43% | 2.999 | 51.43% |
| 21 | 1.521 | 1.544 | 0.02341 | 101.54% | 2.000 | 77.21% |
| 22 | 1.521 | 1.586 | 0.06534 | 104.30% | 2.000 | 79.30% |
| 31 | 1.521 | 1.530 | 0.00906 | 100.60% | 2.797 | 54.69% |
| 32 | 1.521 | 1.522 | 0.00151 | 100.10% | 2.797 | 54.42% |
| 41 | 1.521 | 1.521 | 0.00043 | 100.03% | 3.364 | 45.22% |
| 42 | 1.521 | 1.540 | 0.01954 | 101.29% | 3.364 | 45.78% |
| 51 | 1.521 | 1.520 | −0.00068 | 99.96% | 2.732 | 55.65% |
| 52 | 1.521 | 1.521 | 0.00056 | 100.04% | 2.732 | 55.69% |
| 61 | 1.521 | 1.528 | 0.00736 | 100.48% | 5.200 | 29.39% |
| 62 | 1.521 | 1.520 | −0.00069 | 99.95% | 5.200 | 29.23% |
| ARS | EHD | ARS value | ARS − EHD | (ARS/EHD) % | TP | ARS/TP (%) |
| 11 | 10.655 | 10.757 | 0.10189 | 100.96% | 2.999 | 358.71% |
| 12 | 4.940 | 6.494 | 1.55380 | 131.45% | 2.999 | 216.53% |
| 21 | 4.839 | 6.505 | 1.66618 | 134.43% | 2.000 | 325.27% |
| 22 | 3.137 | 4.624 | 1.48733 | 147.42% | 2.000 | 231.20% |
| 31 | 3.105 | 3.244 | 0.13992 | 104.51% | 2.797 | 115.98% |
| 32 | 2.248 | 2.260 | 0.01133 | 100.50% | 2.797 | 80.78% |
| 41 | 2.424 | 2.428 | 0.00384 | 100.16% | 3.364 | 72.16% |
| 42 | 3.767 | 4.153 | 0.38624 | 110.25% | 3.364 | 123.45% |
| 51 | 4.668 | 4.669 | 0.00046 | 100.01% | 2.732 | 170.92% |
| 52 | 5.280 | 5.334 | 0.05421 | 101.03% | 2.732 | 195.28% |
| 61 | 6.492 | 7.363 | 0.87129 | 113.42% | 5.200 | 141.60% |
| 62 | 6.073 | 6.074 | 0.00092 | 100.02% | 5.200 | 116.80% |

The following contents may be deduced from Table 11 and Table 12.

Values Related to Inflection Point of sixth Embodiment
(Primary Reference Wavelength = 555 nm)

| | | | | | | | |
|---|---|---|---|---|---|---|---|
| HIF411 | 0 | HIF411/ | 0 | SGI411 | 0 | \|SGI411\|/ | 0 |
| | | HOI | | | | (\|SGI411\| + TP4) | |

Although the present invention is disclosed via the aforementioned embodiments, those embodiments do not serve to limit the scope of the present invention. A person skilled in the art may perform various alterations and modifications to the present invention without departing from the spirit and the scope of the present invention. Hence, the scope of the present invention should be defined by the following appended claims.

Despite the fact that the present invention is specifically presented and illustrated with reference to the exemplary embodiments thereof, it should be obvious to a person skilled in the art that, various modifications to the forms and details of the present invention may be performed without departing from the scope and spirit of the present invention defined by the following claims and equivalents thereof.

What is claimed is:

1. An optical image capturing system, from an object side to an image side, comprising:
a first lens with refractive power;
a second lens with refractive power;
a third lens with refractive power;
a fourth lens with refractive power;
a fifth lens with refractive power;
a sixth lens with refractive power; and
an image plane;
wherein the optical image capturing system comprises the six lenses with refractive power and at least one lens among the six lenses is made of glass, a maximum height for image formation in the optical image capturing system is denoted by HOI, at least one lens among the first lens to the sixth lens has positive refractive power, focal lengths of the first lens through the sixth lens are respectively f1, f2, f3, f4, f5 and f6, a focal length of the optical image capturing system is f, an entrance pupil diameter of the optical image capturing system is HEP, a distance on an optical axis from an object side of the first lens to the image plane is HOS, a distance on the optical axis from the object side of the first lens to an image side of the sixth lens is InTL, a half maximum angle of view of the optical image capturing system is HAF, a length of outline curve from a first axial point on any surface of any one of the six lenses to a first coordinate point of vertical height with a distance of a half of the entrance pupil diameter from the optical axis on the surface along the outline of the surface is denoted as ARE, and the following relationships are satisfied: 1.0≤f/HEP≤10.0, 0 deg<HAF≤150 deg, 0.5≤HOS/f≤15 and 0.9≤2 (ARE/HEP)≤2.0.

2. The optical image capturing system of claim 1, wherein the following relationship is satisfied: 0.5≤HOS/HOI≤10.

3. The optical image capturing system of claim 1, wherein a distance between the third lens and the fourth lens on the optical axis is IN34, a distance between the fourth lens and the fifth lens on the optical axis is IN45, and the following relationship is satisfied: IN34>IN45.

4. The optical image capturing system of claim 1, wherein a distance between the fourth lens and the fifth lens on the optical axis is IN45, a distance between the fifth lens and the sixth lens on the optical axis is IN56 and the following relationship is satisfied: IN45>In56.

5. The optical image capturing system of claim 1, wherein an air gap exists respectively among each of the six lenses.

6. The optical image capturing system of claim 1, wherein TV distortion for image formation in the optical image capturing system is TDT, the maximum height for image formation on the image plane perpendicular to the optical axis in the optical image capturing system is denoted by HOI, a lateral aberration of the longest operation wavelength of visible light of a positive direction tangential fan of the optical image capturing system passing through an edge of the entrance pupil and incident on the image plane by 0.7 HOI is denoted as PLTA, and a lateral aberration of the shortest operation wavelength of visible light of the positive direction tangential fan of the optical image capturing system passing through the edge of the entrance pupil and incident on the image plane by 0.7 HOI is denoted by PSTA, a lateral aberration of the longest operation wavelength of visible light of a negative direction tangential fan of the optical image capturing system passing through the edge of the entrance pupil and incident on the image plane by 0.7 HOI is denoted as NLTA, a lateral aberration of the shortest operation wavelength of visible light of the negative direction tangential fan of the optical image capturing system passing through the edge of the entrance pupil and incident on the image plane by 0.7 HOI is denoted by NSTA, a lateral aberration of the longest operation wavelength of visible light of a sagittal fan of the optical image capturing system passing through the edge of the entrance pupil and incident on the image plane by 0.7 HOI is denoted by SLTA, a lateral aberration of the shortest operation wavelength of visible light of the sagittal fan of the optical image capturing system passing through the edge of the entrance pupil and incident on the image plane by 0.7 HOI is denoted by SSTA, and the following relationships are satisfied: PLTA≤100 μm; PSTA≤100 μm; NLTA≤100 μm; NSTA≤100 μm; SLTA≤100 μm; and SSTA≤100 μm; |TDT|<250%.

7. The optical image capturing system of claim 1, wherein a maximum effective half diameter position of any surface of any one of the six lenses is denoted as EHD, a length of outline curve from the first axial point on any surface of any one of the six lenses to the maximum effective half diameter position of the surface along the outline of the surface is denoted as ARS, and the following relationship is satisfied: 0.9≤ARS/EHD≤2.0.

8. The optical image capturing system of claim 1, wherein a length of outline curve from a second axial point on an object side of the sixth lens to a second coordinate point of vertical height with the distance of a half of the entrance pupil diameter from the optical axis on the object side of the sixth lens along the outline of the object side of the sixth lens is denoted as ARE61, a length of outline curve from a third axial point on the image side of the sixth lens to a third coordinate point of vertical height with the distance of a half of the entrance pupil diameter from the optical axis on the image side of the sixth lens along the outline of the image side of the sixth lens is denoted as ARE62, a thickness of the sixth lens on the optical axis is expressed as TP6, and the following relationships are satisfied: 0.05≤ARE61/TP6≤35 and 0.05≤ARE62/TP6≤35.

9. The optical image capturing system of claim 1, further comprising an aperture stop, a distance from the aperture stop to the image plane on the optical axis is InS, and the following relationship is satisfied: 0.1≤InS/HOS≤1.1.

10. An optical image capturing system, from an object side to an image side, comprising:
a first lens with negative refractive power;
a second lens with refractive power;
a third lens with refractive power;
a fourth lens with refractive power;
a fifth lens with refractive power;
a sixth lens with refractive power; and
an image plane;
wherein the optical image capturing system comprises the six lenses with refractive power, a maximum height for image formation on the image plane perpendicular to an optical axis in the optical image capturing system is denoted by HOI, at least two lenses among the first lens to the fifth lens are made of glass, at least one lens among the second lens to the sixth lens has positive refractive power, focal lengths of the first lens through the sixth lens are respectively f1, f2, f3, f4, f5 and f6, a focal length of the optical image capturing system is f, an entrance pupil diameter of the optical image capturing system is HEP, a distance on the optical axis from an object side of the first lens to the image plane is HOS, a distance on the optical axis from the object side of the first lens to an image side of the sixth lens is InTL, a half maximum angle of view of the optical image capturing system is HAF, a length of outline curve from a first axial point on any surface of any one of the six lenses to a first coordinate point of vertical height with a distance of a half of the entrance pupil diameter from the optical axis on the surface along the outline of the surface is denoted as ARE, and the following relationships are satisfied: 1.0≤f/HEP≤10.0, 0 deg<HAF≤150 deg, 0.5≤HOS/f≤15 and 0.9≤2 (ARE/HEP)≤2.0.

11. The optical image capturing system of claim 10, wherein a distance between the third lens and the fourth lens on the optical axis is IN34, a distance between the fourth lens and the fifth lens on the optical axis is IN45, and the following relationship is satisfied: IN34>IN45.

12. The optical image capturing system of claim 10, wherein a distance between the fourth lens and the fifth lens on the optical axis is IN45, a distance between the fifth lens and the sixth lens on the optical axis is IN56 and the following relationship is satisfied: IN45>In56.

13. The optical image capturing system of claim 10, wherein a maximum effective half diameter position of any surface of any one of the six lenses is denoted as EHD, and a length of outline curve from the axial point on any surface of any one of the six lenses to the maximum effective half diameter position of the surface along the outline of the surface is denoted as ARS, and the following relationship is satisfied: 0.9≤ARS/EHD≤2.0.

14. The optical image capturing system of claim 10, wherein the maximum height for image formation on the image plane perpendicular to the optical axis in the optical image capturing system is denoted by HOI, a lateral aberration of the longest operation wavelength of visible light of a positive direction tangential fan of the optical image capturing system passing through an edge of the entrance pupil and incident on the image plane by 0.7 HOI is denoted as PLTA, and a lateral aberration of the shortest operation wavelength of visible light of the positive direction tangential fan of the optical image capturing system passing through the edge of the entrance pupil and incident on the image plane by 0.7 HOI is denoted as PSTA, a lateral aberration of the longest operation wavelength of visible light of a negative direction tangential fan of the optical image capturing system passing through the edge of the entrance pupil and incident on the image plane by 0.7 HOI is denoted as NLTA, a lateral aberration of the shortest operation wavelength of visible light of the negative direction tangential fan of the optical image capturing system passing through the edge of the entrance pupil and incident on the image plane by 0.7 HOI is denoted as NSTA, a lateral aberration of the longest operation wavelength of visible light of a sagittal fan of the optical image capturing system passing through the edge of the entrance pupil and incident on the image plane by 0.7 HOI is denoted by SLTA, a lateral aberration of the shortest operation wavelength of visible light of the sagittal fan of the optical image capturing system passing through the edge of the entrance pupil and incident on the image plane by 0.7 HOI is denoted by SSTA, and the following relationships are satisfied: PLTA≤80 μm; PSTA≤80 μm; NLTA≤80 μm; NSTA≤80 μm; SLTA≤80 μm; SSTA≤80 μm, and HOI>1.0 mm.

15. The optical image capturing system of claim 10, wherein a distance between the first lens and the second lens on the optical axis is IN12, and the following relationship is satisfied: 0<IN12/f≤5.0.

16. The optical image capturing system of claim 10, wherein a distance between the fifth lens and the sixth lens on the optical axis is IN56, and the following relationship is satisfied: 0<IN56/f≤3.0.

17. The optical image capturing system of claim 10, wherein the distance from the fifth lens to the sixth lens on the optical axis is IN56, a thickness of the fifth lens and a thickness of the sixth lens on the optical axis are respectively TP5 and TP6, and the following relationship is satisfied: 0.1≤(TP6+IN56)/TP5≤50.

18. The optical image capturing system of claim 10, wherein the distance from the first lens to the second lens on the optical axis is IN12, a thickness of the first lens and a thickness of the second lens on the optical axis are respectively TP1 and TP2, and the following relationship is satisfied: 0.1≤(TP1+IN12)/TP2≤10.

19. The optical image capturing system of claim 10, wherein at least one lens among the first lens through the sixth lens is a light filtering element with a wavelength of less than 500 nm.

20. An optical image capturing system, from an object side to an image side, comprising:
a first lens with negative refractive power;
a second lens with negative refractive power;
a third lens with refractive power;
a fourth lens with refractive power;
a fifth lens with refractive power;
a sixth lens with refractive power; and
an image plane; wherein the optical image capturing system comprises the six lenses with refractive power, a maximum height for image formation on the image plane perpendicular to an optical axis in the optical image capturing system is denoted by HOI, at least one lens among the first lens to the sixth lens is made of glass; focal lengths of the first lens through the sixth lens are respectively f1, f2, f3, f4, f5 and f6, a focal length of the optical image capturing system is f, an entrance pupil diameter of the optical image capturing system is HEP, a half maximum angle of view of the optical image capturing system is HAF, a distance on the optical axis from an object side of the first lens to the image plane is HOS, a distance on the optical axis from the object side of the first lens to an image side of the sixth lens is InTL, a length of outline curve from a first axial point on any surface of any one of the six lenses to a first coordinate point of vertical height with a distance of a half of the entrance pupil diameter from the optical axis on the surface along the outline of the surface is denoted as ARE, and the following relationships are satisfied: 1.0≤f/HEP≤10, 0 deg<HAF≤150 deg, 0.5≤HOS/f≤15, 0.5≤HOS/HOI≤10, and 0.9≤2 (ARE/HEP)≤2.0.

21. The optical image capturing system of claim 20, wherein the maximum height for image formation on the image plane perpendicular to the optical axis in the optical image capturing system is denoted by HOI, a lateral aberration of the longest operation wavelength of visible light of a positive direction tangential fan of the optical image capturing system passing through an edge of the entrance pupil and incident on the image plane by 0.7 HOI is denoted as PLTA, and a lateral aberration of the shortest operation wavelength of visible light of the positive direction tangential fan of the optical image capturing system passing through the edge of the entrance pupil and incident on the image plane by 0.7 HOI is denoted as PSTA, a lateral aberration of the longest operation wavelength of visible light of a negative direction tangential fan of the optical image capturing system passing through the edge of the entrance pupil and incident on the image plane by 0.7 HOI is denoted by NLTA, a lateral aberration of the shortest operation wavelength of visible light of the negative direction tangential fan of the optical image capturing system passing through the edge of the entrance pupil and incident on the image plane by 0.7 HOI is denoted as NSTA, a lateral aberration of the longest operation wavelength of visible light of a sagittal fan of the optical image capturing system passing through the edge of the entrance pupil and incident on the image plane by 0.7 HOI is denoted by SLTA, a lateral aberration of the shortest operation wavelength of visible light of the sagittal fan of the optical image capturing system passing through the edge of the entrance pupil and incident on the image plane by 0.7 HOI is denoted by SSTA, and the following relationships are satisfied: PLTA≤80 μm; PSTA≤80 μm; NLTA≤80 μm; NSTA≤80 μm; SLTA≤80 μm; SSTA≤80 μm, and HOI>1.0 mm.

22. The optical image capturing system of claim 20, wherein an air gap exists respectively among each of the six lenses.

23. The optical image capturing system of claim 20, wherein a distance between the third lens and the fourth lens on the optical axis is IN34, a distance between the fourth lens and the fifth lens on the optical axis is IN45, and the following relationship is satisfied: IN34>IN45.

24. The optical image capturing system of claim 20, wherein a distance between the fourth lens and the fifth lens on the optical axis is IN45, a distance between the fifth lens and the sixth lens on the optical axis is IN56 and the following relationship is satisfied: IN45>In56.

25. The optical image capturing system of claim 20, further comprising an aperture stop, an image sensing device and a driving module, wherein the image sensing device is disposed on the image plane, a distance on the optical axis from the aperture stop to the image plane is InS, and the driving module couples with the lenses to displace the lenses, and the following relationship is satisfied: 0.2≤InS/HOS≤1.1.
